(19) United States
(12) Patent Application Publication
(10) Pub. No.: US 2025/0011167 A1
(43) Pub. Date: Jan. 9, 2025

(54) METHODS FOR GENERATING HYDROGEN GAS AND OXYGEN GAS

(71) Applicant: RADICAL NRG LTD., Hadera (IL)

(72) Inventors: Achiad DASKALO, Lehavim (IL); Matat BUZAGLO-GERSHKOVICH, Hadera (IL); Asaf DOV, Beer Sheva (IL)

(21) Appl. No.: 18/895,253

(22) Filed: Sep. 24, 2024

Related U.S. Application Data
(63) Continuation-in-part of application No. 18/626,949, filed on Apr. 4, 2024, now abandoned.
Application No. 18/626,949 is a continuation-in-part of application No. PCT/IL2023/050210, filed on Feb. 28, 2023.
(60) Provisional application No. 63/314,637, filed on Feb. 28, 2022.

(51) Int. Cl. C01B 3/06; B01J 8/02; C01B 13/02

(52) U.S. Cl. CPC C01B 3/063; B01J 8/0278; C01B 13/0203

(57) ABSTRACT

The present disclosure relates to methods and reactors for generating of gas and specifically for generation of oxygen gas and hydrogen gas.

### TECHNOLOGICAL FIELD

The present disclosure relates to methods and reactors for generating hydrogen gas and oxygen gas.

### BACKGROUND ART

References considered to be relevant as background to the presently disclosed subject matter are listed below:

Acknowledgement of the above references herein is not to be inferred as meaning that these are in any way relevant to the patentability of the presently disclosed subject matter.

### BACKGROUND

Efforts are underway to use alternative energy sources due to environmental concerns and regulations to eliminate CO₂ emission in the transportation and petrochemical industries. The common alternative energy sources existing today are based on wind or solar energy, which are inconsistent therefore rely on storage with low economic efficiency. Another alternative energy source uses nuclear reactors for electricity production; however, nuclear energy is also limited due to negative perception. Thus, the existing alternative energy sources have disadvantages that drive the continued search for an available and economical alternate energy source.

Existing alternative energy sources, such as solar, wind, and nuclear energy, have disadvantages such as inconsistency, low economic efficiency, and negative public perception, respectively. Fuel cells that use hydrogen as fuel are an option for clean electricity generation; however, existing methods for producing hydrogen are expensive. Furthermore, existing methods for producing hydrogen require electricity. For example, electrolyzers produce hydrogen by water splitting using electricity. For green hydrogen production, the electricity is produced by renewable green energy such as solar, wind or nuclear power sources. Such techniques are not cost effective when examining the electricity-to-hydrogen conversion due to reliance on energy storage in the case of wind and solar energy, or negative perception in case of nuclear energy.

### GENERAL DESCRIPTION

The present invention is based on the development of methods and reactors for generation of oxygen gas and/or hydrogen gas in temporal and/or spatial separated steps.

The methods and reactors described herein permit control not only on the type of gases that would be produced (generated), i.e., hydrogen gas or oxygen gas, but also on the ability to produce the gas in a sequential or continuous fashion.

As shown in the Examples below, it was found that irradiating a metal oxide (MO) with radiation, including, inter alia, alpha radiation, beta radiation or gamma radiation, reduced the mass of the metal oxide. It was suggested that upon irradiation of the metal oxide, oxygen atoms are released (removed) from the metal oxide, possibly from the metal oxide surface, generating vacant oxygen sites in the metal oxide as well as oxygen gas.

In the following text, a metal oxide characterized by having vacant oxygen sites is denoted as Oxygen Vacancy Metal Oxide (OVMO). It should be noted that the term OVMO encompasses a metal oxide molecule in which one or more of the oxygen atoms was removed (released).

Surprisingly, the observed reduction in the metal oxide mass and the generation of oxygen gas occurred at a temperature that is below the temperature required to overcome the MO's binding energy, at times even at a temperature that is 2-fold, 3-fold, 5-fold lower. In other words, the method described herein did not involve heating the metal oxide to a temperature typically required to overcome the MO's binding energy, in order to release oxygen atoms, and yet, OVMO was formed and oxygen gas was generated.

As further showed herein below, in the presence of oxygen, in the surrounding air as well as in the presence of water, oxygen atom(s) can recombine with the OVMO such that the OVMO can undergo regeneration to form the MO. Hence, considering the reversibility of the MO-OVMO, it was suggested that oxygen gas can be continuously generated, for example, under conditions of continuous exposure to irradiation. In such examples, the formed OVMO recombines with oxygen atom(s), to regenerate the MO that can be further used for generation of oxygen gas.

As further shown in the Examples below, exposure of the OVMO to water vapor, results in generation of hydrogen gas.

It was suggested that in the presence of the OVMO, water decomposes (splits) due to recombination (reabsorption) of oxygen atoms (from the water vapor) to the OVMO, regenerating the MO and generating hydrogen gas.

Hence, it was further suggested that the OVMO may be suitable for generation of hydrogen gas following exposure to water vapor. This method for generating hydrogen may be locally, i.e. at the site where the OVMO was generated or may be remote, i.e. by transferring or transporting the OVMO, to a facility. In both cases, the OVMO would be exposed to water vapor for generation of hydrogen.

Additionally, or alternatively, the methods enable sequential generation of oxygen gas and hydrogen gas (in an interrelated method). Specifically, irradiating the metal oxide results in oxygen gas generation and OVMO formation and upon exposure of the OVMO to water vapor hydrogen gas is generated and the metal oxide is regenerated, for further cycles. Hence, controlling the timing of exposure to one or more of radiation or water vapor, provides tools to control the type of the generated gas.

In accordance with some aspect, the present disclosure provides a method comprising irradiating a metal oxide to obtain a metal oxide with oxygen vacancy (OVMO) and oxygen gas, wherein the irradiating is at a temperature below a temperature required to overcome the metal oxide binding energy.

In accordance with some other aspect, the present disclosure provides a method comprising irradiating a metal oxide to obtain a metal oxide with oxygen vacancy (OVMO) and oxygen gas, wherein the metal oxide is maintained at a temperature below a temperature required to overcome the metal oxide binding energy.

In the following text, when referring to the methods it is to be understood as also referring to the reactors or systems or generators disclosed herein. Thus, whenever providing a feature with reference to the method, it is to be understood as defining the same feature with respect to the reactor or system or generator mutatis mutandis.

It should be noted that reference made to a temperature below a temperature required to overcome the metal oxide binding energy should be understood as a temperature lower than the temperature typically required to release at least one oxygen atom from the metal oxide.

As appreciated, the binding energy of a metal oxide is the energy required to break the bonds between the metal and at least one oxygen atom. It should be noted that at times there are two binding energies, one for each oxygen atom within a metal oxide molecule.

For example, for a metal oxide, in which the temperature for releasing an oxygen atom is about 1500° C., in the methods developed herein, an oxygen atom was released at lower temperatures, even 4-fold or 5-fold lower. It was suggested that the lower temperature was due to the absorption of energy by the metal oxide as a consequence of the irradiation.

As appreciated, the metal oxide can be irradiated with various radiation provided that the radiation is capable of releasing at least one oxygen atom from the metal oxide compound at a temperature lower than the temperature required to overcome the MO's binding energy. In other words, the radiation in accordance with the present disclosure is a radiation that does not require heating the metal oxide to a temperature typically required to overcome the MO's binding energy. In some examples, the methods are adopted such that the metal oxide is maintained (kept) at a temperature lower than the temperature required to overcome the MO's binding energy.

In some examples, during irradiation, the metal oxide is at a temperature of at most about 1500° C., at times at most about 1000° C., at times at most about 500° C., at times at most about 100° C., at times at most about 80° C., at times at most 50° C.

In some examples, during irradiation, the metal oxide is at a temperature of between about 1° C. and about 500° C., at times between about 2° C. and about 400° C., at times between about 3° C. and about 300° C., at times between about 4° C. and about 200° C., at times between about 5° C. and about 150° C.

In some examples, during irradiation, the metal oxide is at a temperature of between about 20° C. and about 500° C., at times between about 20° C. and about 400° C., at times between about 20° C. and about 300° C., at times between about 20° C. and about 200° C., at times between about 20° C. and about 150° C. at times between about 20° C. and about 100° C., at times between about 20° C. and about 80° C.

In some examples, during irradiation, the metal oxide is at a temperature of between about 30° C. and about 500° C., at times between about 50° C. and about 500° C., at times between about 70° C. and about 500° C., at times between about 100° C. and about 500° C., at times between about 150° C. and about 500° C.

In some examples, the methods are applicable to generate OVMO and oxygen gas, wherein the metal oxide is a temperature of about 5° C., at times about 10° C., at times about 15° C., at times about 17° C., at times about 20° C., at times about 22° C., at times about 25° C., at times about 28° C., at times about 30° C., at times about 35° C.

In some examples, the methods are applicable to generate OVMO and oxygen gas, wherein the metal oxide is a temperature of about 50° C., at times about 60° C., at times about 70° C., at times about 80° C., at times about 90° C., at times about 100° C., at times about 110° C., at times about 120° C., at times about 130° C., at times about 140° C.

In some examples, the methods are applicable to generate OVMO and oxygen gas, wherein the metal oxide is a temperature of about 200° C., at times about 220° C., at times about 240° C., at times about 260° C., at times about 300° C., at times about 350° C., at times about 400° C., at times about 450° C., at times about 500° C.

In some embodiments, the temperature may be by about 3-fold, about 4-fold, about 5-fold, about 6-fold, about 7-fold, about 8-fold, about 9-fold, about 10-fold, about 12-fold, about 15-fold, about 17-fold, about 20-fold, about 22-fold, about 25-fold, about 27-fold, about 30-fold, about 32-fold, about 35-fold, about 37-fold, about 40-fold, about 42-fold, about 45-fold, about 47-fold, about 50-fold, lower than the temperature required to overcome the MO's binding energy.

As appreciated, the temperature that breaks the bonds between the metal and oxygen atoms may be calculated by measuring the energy required to break the bonds by any known method in the field.

As appreciated, the term radiation refers to emission or transmission of energy in the form of electromagnetic waves or particles. The term radiation as used herein encompasses natural radiation as well as man-made radiation. In addition, the radiation used herein refers to thermal radiation as well as to non-thermal radiation.

In some embodiments, the radiation is thermal radiation.

In some embodiments, the radiation is non-thermal radiation.

The term non-thermal radiation as used herein refers to radiation that does not depend on the temperature of the source.

In some examples, the irradiation is at atmospheric pressure. In some embodiments, the radiation carries at least 10 eV per emitted particle or photon.

In some examples, the radiation is electromagnetic radiation. In some examples, the electromagnetic radiation comprising of high energy photons.

In some examples, the electromagnetic radiation is or comprises at least one of an ultraviolet, X-rays, and gamma radiation (γ).

In some examples, the electromagnetic radiation is or comprises X-rays. X-rays are a form of electromagnetic radiation with a wavelength typically ranging from 0.01 to 10 nanometers.

In some examples, the radiation is or comprises particle radiation. In some examples, the particle radiation is alpha radiation (α) or beta radiation (β).

In some embodiments, a source of the radiation is a radioactive material.

There are various radioactive materials that can be used in the present disclosure including natural radioactive material and man-made radioactive materials. In some examples, the radioactive material is at least one or more of Co-60, Sr-90, Cs-137, Cs-135 and Mo-99.

As appreciated, a radioactive material emits α radiation, β radiation, or γ radiation or combination thereof. radiation such the one released from the radioactive material can include one or more of alpha radiation, beta radiation, or gamma radiation. Alpha, beta, and gamma radiation each differ in mass, charge, energy and consequently, the penetration depth through a medium, and current commercial applications.

In some examples, the radiation is selected from the group consisting of alpha radiation, beta radiation, and gamma radiation.

In some examples, the radiation is alpha radiation (particles). Alpha particles consist of two protons and two neutrons (e.g., A Helium nucleus) and are the heaviest type of radiation particle, carrying a positive charge. Many of the naturally occurring radioactive materials in the earth, like uranium and thorium, emit alpha particles due to spontaneous fission reactions. Alpha radiation is not able to penetrate skin and travels a very short distance through air. Note that this is not a nuclear chain reactor, but natural decay.

In some examples, the radiation is beta radiation (particles). Beta particle is an electron or positron that is not attached to an atom. It has a small mass and has either negative or positive charge. Beta radiation may travel meters in air and can penetrate human skin to the innermost layer of the epidermis where new skin cells are produced. If beta-emitting contaminants remain on the skin for a prolonged period, they may cause skin injury. Clothing and turnout gear provide some protection against most beta radiation. Personal protective equipment should be worn to protect clothing and otherwise uncovered skin from contamination of all types.

In some examples, the radiation is gamma radiation. Gamma radiation is an electromagnetic radiation; a known example are X-rays. Gamma rays are specific to radioactive decay from radio-nuclei. These rays are like sunlight but have much more energy per photon—about a million times more. Quantum mechanics views electromagnetic waves as a flow of discrete particles called photons, which carry no charge, and have a very low mass. Gamma radiation is the most penetrative, with the ability to travel meters through air and many centimeters into human tissue.

In some examples, the radiation is UV radiation. UV radiation, or ultraviolet radiation ranges in wavelength from about 10 to 400 nanometers and is divided into three categories: UV-A, UV-B, and UV-C, based on their wavelengths and energy. As described herein, the UV radiation may be applied using a UV source. In some examples, the UV source is UV lamp.

As described herein, irradiating at least one metal oxide results in a metal oxide having vacant oxygen sites (denoted as OVMO) due to release of oxygen atoms. Hence, as described herein, the radiation particle/photon energy in accordance with the present disclosure should be above the metal oxide binding energies.

When referring to metal oxide binding energies, it encompasses oxygen-oxygen and/or metal-oxygen. Typically, the first oxygen atom that binds to the metal has a binding energy that is lower than the second oxygen atom.

Metal oxide as used herein refers to a crystalline solid containing a metal cation and an oxide anion. It should be noted that the term metal oxide generally refers to the metal cation having one or more oxygen anions.

In the context of the present disclosure, a metal oxide may comprise a single metal atom or a combination of metal atoms, being the same or different.

The present disclosure is not limited to a specific metal oxide and can be applied to a variety of metal oxides as described herein.

In accordance with the present disclosure, the metal oxide is characterized by a reducibility that permit formation of an oxygen vacancy in the metal oxide.

In some examples, the metal oxide is a reducible oxide.

A reducible oxide as used herein refers to solid state materials characterized by the capability to exchange oxygen.

As described herein, it was surprisingly found that the metal oxide is reducible, i.e. capable of forming oxygen vacancies, without heating the metal oxide to the temperature that is required to overcome the binding energy. As generally known in the art, forming oxygen vacancies in metal oxides requires conditions involving temperature that are above the temperature required to overcome the metal oxide binding energy.

Hence, the metal oxide of the present disclosure tends to lose oxygen or to donate it to a species with consequent change in the surface composition, to thereby generate the metal oxide having oxygen vacancies, for example, the change may be from MOₘ to MOₘ₋ₓ.

The metal in each metal oxide may be selected among metallic elements, including alkali metals, alkaline earths, transition metals, a lanthanide, an actinide of the Periodic Table of the Elements.

In some examples, the metal in the metal oxide is a transition metal, a lanthanide, an actinide or any combination thereof.

In some embodiments, the metal in the metal oxide is at least one alkali metal. Alkali metal is a metal located in the first column, or Group 1, of the Periodic Table of the Elements. In some embodiments, the alkali metal is at least one of lithium (Li), sodium (Na), potassium (K), rubidium (Rb), cesium (Cs), and francium (Fr).

In some embodiments, the metal in the metal oxide is at least one alkaline earth metal. Alkaline earth metal is a metal located in Group 2, of the Periodic Table of the Elements. In some embodiments, the alkaline earth metal is at least one of beryllium (Be), magnesium (Mg), calcium (Ca), strontium (Sr), barium (Ba), and radium (Ra). In some embodiments, the metal in the metal oxide is a transition metal.

The transition metal as used herein encompasses any element in the d-block elements (groups 3 to 12 on the periodic table) as well as the f-block elements (including lanthanide and actinide). Hence, the transition metal forming part of the metal oxide of the present disclosure also encompasses an inner transition metal.

As noted herein, the metal can be a single metal forming a metal oxide or a combination of different metal atoms forming a combination of metal oxides. Hence, when referring to a metal it should be understood as referring also to combination of metals and hence a combination of metal oxides (being the same or different).

In some examples, the metal or combination of metals is a metal from the d-block of elements of the Periodic Table of the Elements.

In some examples, the metal or combination of metals is a metal from the f-block elements of the Periodic Table of the Elements.

In some examples, the metal or combination of metals is a metal from the d-block of elements of the Periodic Table of the Elements and/or the f-block elements of the Periodic Table of the Elements.

In some examples, the metal is a lanthanide.

In some examples, the metal is an actinide.

In some examples, the metal in the metal oxide is at least one metal selected from the group consisting of scandium (Sc), titanium (Ti), vanadium (V), chromium (Cr), manganese (Mn), iron (Fe), cobalt (Co), nickel (Ni), copper (Cu), and zinc (Zn). The period 5 transition metals are yttrium (Y), zirconium (Zr), niobium (Nb), molybdenum (Mo), technetium (Tc), ruthenium (Ru), rhodium (Rh), palladium (Pd), silver (Ag), cadmium (Cd), lanthanum (La), hafnium (Hf), tantalum (Ta), tungsten (W), rhenium (Re), osmium (Os), iridium (Ir), platinum (Pt), gold (Au), and mercury (Hg), actinium (Ac), rutherfordium (Rf), dubnium (Db), seaborgium (Sg), bohrium (Bh), hassium (Hs), meitnerium (Mt), darmstadtium (Ds), roentgenium (Rg), ununbiium (Uub), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), thorium (Th), protactinium (Pa), uranium (U), neptunium (Np), plutonium (Pu), americium (Am), curium (Cm), berkelium (Bk), californium (Cf), einsteinium (Es), fermium (Fm), mendelevium (Md), nobelium (No), and lawrencium (Lr).

In some examples, the metal in the metal oxide is at least one metal selected from the group consisting of scandium (Sc), titanium (Ti), vanadium (V), chromium (Cr), manganese (Mn), iron (Fe), cobalt (Co), nickel (Ni), copper (Cu), and zinc (Zn). The period 5 transition metals are yttrium (Y), zirconium (Zr), niobium (Nb), molybdenum (Mo), technetium (Tc), ruthenium (Ru), rhodium (Rh), palladium (Pd), silver (Ag), and cadmium (Cd).

In some examples, the metal in the metal oxide is at least one metal selected from the group consisting of lanthanum (La), hafnium (Hf), tantalum (Ta), tungsten (W), rhenium (Re), osmium (Os), iridium (Ir), platinum (Pt), gold (Au), and mercury (Hg), actinium (Ac), (Rf), dubnium (Db), seaborgium (Sg), bohrium (Bh), hassium (Hs), meitnerium (Mt), darmstadtium (Ds), roentgenium (Rg), and ununbium (Uub).

In some examples, the metal in the metal oxide being a lanthanide is at least one metal selected from the group consisting of cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

In some examples, the metal in the metal oxide being a actinide In some examples, the metal in the metal oxide is at least one metal selected from the group consisting of thorium (Th), protactinium (Pa), uranium (U), neptunium (Np), plutonium (Pu), americium (Am), curium (Cm), berkelium (Bk), californium (Cf), einsteinium (Es), fermium (Fm), mendelevium (Md), nobelium (No), and lawrencium (Lr).

In some embodiments, the metal is Zr, Ce, Fe, Ni or Ti.

In some embodiments, the metal is Ce.

In some embodiments, the metal oxide is one or more of ZrO₂ (zirconia), CeO₂ (ceria), FeO (ferrous oxide), NiO (nickel(II) oxide) TiO (Titanium(II) Oxide) or any combination thereof.

In some embodiments, the metal oxide is CeO₂.

The metal oxide in accordance with the present disclosure can be in a solid-state form. The term solid state refers to a physical state in which atoms or molecules are closely packed together in a fixed position, forming a solid substance with a definite shape and volume.

In some examples, the metal oxide is in a powder form. Powder solid state to a material in the form of fine particles or powder, the particles are typically smaller than 1 millimeter in size, and can be composed of either crystalline or amorphous materials.

In some other examples, the metal oxide is in a slurry form.

In some other examples, the metal oxide may be used in the form of a coating. In some examples, the metal oxide may be used to coat an anode.

In some examples, the metal oxide is in a film form.

As described herein, the metal oxide is configured to release at least one oxygen atom upon exposure to radiation (i.e. when being irradiated). In other words, the metal oxide undergoes a change from MOₓ to MO_{x-y}, such that Y is an integer between 1 and X. The metal oxide formed after the release of oxygen atom is characterized by having oxygen vacancies. As used herein oxygen vacancy as used herein refers to oxygen atoms that are missing from the metal oxide (e.g. from the crystal form).

As also described herein, the metal oxide having oxygen vacancies is denoted herein as OVMO.

The method comprising exposure a metal oxide to radiation may be represented by the following equation (I):

$${MO}_{x} + {E}_{p}^{\geq B , E} \to {MO}_{x - y} + \frac{y}{2} {O}_{z} \qquad ( I )$$

such that MO represents metal oxide, x represents the number of oxygen atoms on each metal atom in the MO; Ep represent the radiation energy per particle/photon; y represents the amount of oxygen atoms released from the MO (for example the surface; ranges between 1 to x), to form y/2 oxygen molecules (O₂). MO_{x-y} represents the metal oxide having oxygen vacancies (OVMO) that as described herein is characterized by the ability to recombine oxygen atoms, for example, after exposure to water vapor or air.

In some examples, the OVMO are characterized by oxygen vacancies.

The OVMO as used herein refers to a functional form of the metal oxide.

In some examples, the OVMO are surface exposed.

It should be noted that in some examples, the OVMO is stable for at most 48 hours, at times at most 24 hours. When referring to stability, it should be noted that the OVMO maintains at least 50% of the oxygen vacancies for at most 48 hours in case completely exposed to oxygen source (e.g., air or water vapor surroundings). In case of vacuum sealed metal oxide with oxygen vacancies, its stability may last much longer.

The stability of the OVMO can be determined by any known method in the art. Among others, scanning tunneling microscopy (STM), mass spectroscopy (MS), Thermogravimetric analysis (TGA) or X-ray photoelectron spectroscopy (XPS) may be used to characterize these vacancies.

In some embodiments, the method comprises collecting the oxygen gas.

In some embodiments, the method comprises collecting the OVMO.

In accordance with some examples, the method comprises exposing CeO₂ to radioactive radiation. In accordance with some examples, the method comprises exposing CeO₂ to radioactive radiation and generating oxygen gas. In accordance with some examples, the method comprises exposing CeO₂ to radioactive radiation and generating oxygen gas and CeO. In accordance with some examples, the method comprises exposing CeO₂ to radioactive radiation and generating oxygen gas and Ce.

As described herein, the method comprises generating hydrogen gas.

As described herein, the OVMO is characterized by being stable and hence it may be transferred or transported for remote locations that require hydrogen generation. Such hydrogen gas may be used in fuel cells. As appreciated, fuel cells that use hydrogen gas as fuel are an option for clean electricity generation. They can also affect the catalytic activity and reactivity of the material, which can be useful in applications such as fuel cells, catalysts, and gas sensors.

Additionally or alternatively, the method may comprise additional steps in which the OVMO forms hydrogen gas.

In some embodiments, the method comprises exposing the OVMO (comprising oxygen vacancy) to water vapor.

As appreciated, water vapor can be used at various pressures, for example, atmospheric pressure.

The method comprising exposure a OVMO to water (water vapor) may be represented by the following equation (II):

$${MO}_{x - y} + y {H}_{2} O \to {MO}_{x} + y {H}_{2} \qquad ( II )$$

where MOx-y represents the metal oxide having oxygen vacancies (OVMO) that in the presence of water vapor releases hydrogen (H₂) gas and regenerates back to its original form (by recombining with oxygen atoms).

In some embodiments, the method comprising collecting hydrogen gas produced upon exposure of the OVMO to the water vapor.

As described herein, the methods of the present disclosure generation of both oxygen gas and hydrogen gas. Hence, in accordance with some other aspects, the present disclosure provides a method comprising (i) irradiating a metal oxide, to obtain OVMO and oxygen gas; and in (ii) exposing the OVMO to water vapor to generate hydrogen gas and to allow the OVMO to recombine with oxygen.

It should be noted that recombination of OVMO with oxygen atoms essentially regenerates the metal oxide molecules.

In accordance with some examples, the method comprises exposing CeO²⁺ to water vapor. In accordance with some examples, the method comprises exposing Ce⁴⁺ to water vapor.

The method comprising exposure of a metal oxide to radiation (i.e. irradiating the metal oxide) and of the OVMO to water (water vapor) may be represented by the following equation (III):

$${MO}_{x} + {E}_{p}^{\geq B , E} \to {MO}_{x - y} + \frac{y}{2} {O}_{z} \\ {MO}_{x - y} + y {H}_{2} O \to {MO}_{x} + y {H}_{2} \qquad ( III )$$

where MO represents metal oxide, x represents the number of oxygen atoms on each metal atom in the MO molecule; Ep represent the radiation energy per particle/photon; y represents the amount of oxygen atoms released from the MO (for example the surface; ranges between 1 to x), to form y/2 oxygen molecules (O₂), MO_{x-y} represents the OVMO that in the presence of water vapor releases hydrogen (H₂) gas and undergo regeneration (by recombining with oxygen atoms).

In some embodiments, the method may be adapted or used for generating oxygen gas and hydrogen gas.

In some embodiments, the method may be adapted or used for generating oxygen gas.

In some embodiments, the method may be adapted or used for generating hydrogen gas.

As disclosed herein, hydrogen gas may be generated subsequent to generation of oxygen gas, where the metal oxide has oxygen vacancies (OVMO) capable of splitting water in vapor form.

In accordance with some embodiments, the method comprises exposing a metal oxide to a radiation at a first time point and exposing a OVMO to water vapor at a different time point.

In accordance with some examples, the different time point is later to the first time point. In some examples, in which the different time point is later to the first time point, the method comprises generation of oxygen gas followed by generation of hydrogen gas.

In some examples, the method comprises sequential generation of oxygen gas and hydrogen gas. In such examples, the method comprises repeating the steps of generation of oxygen gas followed by generation of hydrogen gas. In other words, the method comprises repeating steps (i) and (ii) in a sequential order in order to allow sequential generation of oxygen gas and hydrogen gas.

In some embodiments, the method comprised evacuating the oxygen gas before exposing the OVMO to water vapor.

In some embodiments, the method comprised evacuating the hydrogen gas before exposing the metal oxide to radiation.

As appreciated, each one of oxygen gas or hydrogen gas may be evacuated to be collected for further purposes.

In some embodiments, in which the method comprises sequential generation of oxygen gas and hydrogen gas, the method comprises continuous movement of the metal oxide and the OVMO. As described herein, the metal oxide is required for oxygen gas generation whereas the OVMO is required for hydrogen gas generation.

Hence, in accordance with some aspects, the present disclosure provides a method for continuous sequential generation of oxygen gas and hydrogen gas, the method comprises:
irradiating a metal oxide, to obtain metal oxide comprising oxygen vacancy (OVMO) and oxygen gas,
evacuating at least part of the oxygen gas,
exposing the OVMO to water vapor to regenerate the metal oxide and generate hydrogen gas,
evacuating at least part of the hydrogen gas.

The steps above when used for continuous sequential generation of oxygen gas and hydrogen gas are denoted herein as “sequential operation cycle”.

As appreciated, the method comprises sequential operation cycle may be repeated several times upon demand.

In some embodiments, the method comprises at least two sequential operation cycles, each sequential operation cycle comprises generation of hydrogen gas and of oxygen gas.

In some embodiments, in the method, the different time point is the same as the time point. In some examples, in which the different time point is the same as the first time point, the method comprises generation of oxygen gas in parallel to generation of hydrogen gas.

In some examples, the method comprises generation of oxygen gas and hydrogen gas. In such examples, the method comprises repeating the steps of generation of oxygen gas and of generation of hydrogen gas. In other words, the method comprises repeating steps (i) in order to allow generation of oxygen gas and of step (ii) in order to allow generation of hydrogen gas.

In some embodiments, the method comprised evacuating the oxygen gas.

In some embodiments, the method comprised evacuating the hydrogen gas.

As appreciated, each one of oxygen gas or hydrogen gas may be evacuated to be collected for further purposes.

Hence, in accordance with some aspects, the present disclosure provides a method for continuous generation of oxygen gas and hydrogen gas, the method comprises:
exposing metal oxide particles to a radiation, to obtain OVMO (comprising oxygen vacancy) and oxygen gas,
exposing the OVMO y to water vapor to regenerate the metal oxide particles and generate hydrogen gas.

The steps above when used for continuous generation of oxygen gas and hydrogen gas are denoted herein as “continuous operation cycle”.

As appreciated, the method comprises continuous operation cycle may be repeated several times upon demand.

In some aspects, the present disclosure provides a method for oxygen gas generation, the method comprises exposing a metal oxide to radioactive radiation.

In some aspects, the present disclosure provides a method for oxygen gas generation, the method comprises exposing CeO₂ to radioactive radiation.

In some aspects, the present disclosure provides a method for oxygen gas generation, the method comprises exposing a metal oxide to radioactive radiation, wherein the metal oxide is a temperature of at most 1000° C.

In some aspects, the present disclosure provides a method for oxygen gas generation, the method comprises exposing CeO₂ to radioactive radiation, wherein the CeO₂ is at a temperature of at most 1000° C.

In some aspects, the present disclosure provides a method for hydrogen gas generation, the method comprises exposing OVCeO₂ to water vapor.

In some aspects, the present disclosure provides a method for gas generation, the method comprises exposing a metal oxide to radioactive radiation to form OVMO and exposing the OVMO to water vapor.

In some aspects, the present disclosure provides a method for gas generation, the method comprises exposing CeO₂ to radioactive radiation to form OVCeO₂ and exposing the OVCeO₂ to water vapor.

In some examples, in which the method is applicable for CeO₂, the method comprising exposure of a CeO₂ to radiation (i.e. irradiating CeO₂) and of the CeO_{2-y} to water (water vapor) may be represented by the following equation (IV):

$${CeO}_{2} + {E}_{p}^{\geq B , E} \to {CeO}_{2 - y} + \frac{y}{2} {O}_{2} {CeO}_{2 - y} + y {H}_{2} O \to {CeO}_{2} + y {H}_{2} . \qquad ( IV )$$

The present disclosure also provides in accordance with some aspects, a reactor. The reactor as used herein can be considered as an oxygen generator and/or a hydrogen generator.

The reactor comprises a reactor chamber including a gas outlet, and a radiation source, the reactor chamber is configured for holding metal oxide such that upon irradiation by the radiation source, the metal oxide is exposed to the radiation; and upon the exposure to radiation, gas is generated by the metal oxide particles and is being released from the chamber through the gas outlet, wherein the irradiation does not involve heating the metal oxide to a temperature that is above the temperature required to overcome the MO's binding energy.

In some embodiments, the gas outlet is configured for evacuating oxygen gas from the chamber.

In some embodiments, the radiation source is configured to irradiate the metal oxide with radioactive radiation.

The reactor may comprise additional components.

In some embodiments, the chamber comprises means to collect the OVMO from the chamber.

In some embodiments, the chamber comprises a water vapor reservoir.

In some embodiments, the gas outlet configured to evacuate hydrogen gas from the reactor.

In some aspects, it is provided a reactor for generating oxygen gas and hydrogen gas, the reactor comprises at least one chamber, at least one irradiation source and a water reservoir, wherein the at least one chamber is configured for holding at least one metal-oxide and/or OVMO, such that upon irradiation by the radiation source, the metal oxide is exposed to the radiation; and upon the exposure of MO to radiation, oxygen gas and OVMO are generated by the metal oxide and wherein upon exposure of OVMO to water vapor, hydrogen gas is generated and MO is formed.

The reactor comprises in accordance with some examples, at least one gas outlet, at times an oxygen gas outlet and an hydrogen gas outlet.

In some examples, the metal oxide within the at least one chamber is at a temperature below the temperature required to overcome the MO's binding energy.

In some examples, the reactor comprises a conveyor belt.

In some embodiments, the reactor for generating OVMO and oxygen gas is shown in FIG. 13A. In some embodiments, the reactor for generating OVMO and oxygen gas is shown in FIG. 13B.

In some embodiments, the reactor for generating OVMO and oxygen gas is shown in FIG. 15. In some embodiments, the reactor for generating OVMO and oxygen gas is shown in FIG. 16.

In some embodiments, the reactor for generating hydrogen gas is shown in FIG. 17A. In some embodiments, the reactor for generating hydrogen gas is shown in FIG. 17B.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

It should be noted that various embodiments of this invention may be presented in a range format. The description of a range should be considered to have specifically disclosed all the possible sub ranges as well as individual numerical values within that range. For example, description of a range such as from 1 to 6 or between 1 and 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

As used herein, the forms “a”, “an” and “the” include singular as well as plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

It should be noted that the various embodiments and examples detailed herein in connection with various aspects of the invention may be applicable to one or more aspects disclosed herein. It should be further noted that any embodiment described herein, for example, related to method, may be applied separately or in various combinations. Various embodiments and aspects of the present invention as delineated hereinabove and as claimed in the claims section below find experimental support in the following examples. The phrases “in another embodiment” or any refence made to embodiment as used herein do not necessarily refer to different embodiment, although it may. Thus, various embodiments of the invention can be combined (from the same or from different aspects) without departing from the scope of the invention.

Various embodiments and aspects of the present invention as delineated herein above and as claimed in the claims section below find experimental support in the following examples.

Disclosed and described, it is to be understood that this invention is not limited to the particular examples, methods steps, and reactors disclosed herein as such methods steps and reactors may vary somewhat. It is also to be understood that the terminology used herein is used for the purpose of describing particular embodiments only and not intended to be limiting since the scope of the present invention will be limited only by the appended claims and equivalents thereof.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

### EMBODIMENTS

Some embodiments of this disclosure will now be described in the following numbered paragraph. The following description intends to add on the above general description and not limit it in any manner.
1. A method comprising exposing metal oxide to a radiation, to generate an oxygen vacancy metal oxide (OVMO) and oxygen gas.
2. The method of Embodiment No. 1, comprising exposing the metal oxide to irradiation, wherein the metal oxide is at a temperature below the temperature required to overcome the metal oxide binding energy.
3. The method of Embodiment No. 2, wherein the temperature is at most about 1500° C.
4. The method of Embodiment No. 3, wherein the temperature is at most about 500° C.
5. The method of Embodiment No.4, wherein the temperature is at most about 80° C.
6. The method of Embodiment No. 2, wherein the temperature is between about 20° C. and about 500° C.
7. The method of Embodiment No. 1, wherein the radiation is non-thermal radiation.
8. The method of Embodiment No. 1, wherein the radiation is selected from the group consisting of electron beam radiation, alpha radiation, beta radiation, gamma radiation, and UV radiation.
9. The method of any one of Embodiments No. 1 to 8, wherein the metal in the metal oxide is at least one of (i) at least one alkali metal, (ii) at least one alkaline earth metal, (iii) at least one transition metal, (iv) at least one lanthanide metal, (v) at least one actinide metal or (vi) combination thereof.
10. The method of any one of Embodiments No. 1 to 9, wherein the metal in the metal oxide is at least one of (i) at least one transition metal, (ii) at least one lanthanide metal, (iii) at least one actinide metal or (iv) combination thereof.
11. The method of any one of Embodiments No. 1 to 10, wherein the metal in the metal oxide is at least one of Zirconium (Zr), Cerium (Ce), Iron (Fe), Titanium (Ti), Nickel (Ni) or any combination thereof.
12. The method of any one of Embodiments No. 1 to 11, wherein the metal oxide is selected from the group consisting of ZrO₂, CeO₂, FeO, TiO and NiO.
13. The method of Embodiment No. 12, wherein the metal oxide is CeO₂.
14. The method of any one of Embodiments No. 1 to 13, wherein the metal oxide is in a solid state.
15. The method of any one of Embodiments No. 1 to 14, wherein the metal oxide is in a powder form or coating a surface.
16. The method of any one of Embodiments No. 1 to 15, comprising collecting the oxygen gas.
17. The method of any one of Embodiments No. 1 to 16, comprising collecting the OVMO comprising oxygen vacancy.
18. The method of any one of Embodiments No. 1 to 17, comprising exposing the OVMO to water vapor.
19. The method of Embodiment 18, comprising collecting hydrogen gas produced upon exposure of the OVMO to the water vapor.
20. A method comprising:
   (i) exposing metal oxide to a radiation, to obtain OVMO and oxygen gas; and
   (ii) exposing the OVMO to water vapor to regenerate the metal oxide particles and generate hydrogen gas.
21. The method of Embodiment No. 20, comprising exposing the metal oxide to irradiation, wherein the metal oxide is at a temperature below the temperature required to overcome the metal oxide binding energy.
22. The method of Embodiment No. 21, wherein the temperature is at most about 1500° C.
23. The method of Embodiment No. 22, wherein the temperature is at most about 500° C.
24 The method of Embodiment No. 23, wherein the temperature is at most about 80° C.
25. The method of Embodiment No. 21, wherein the temperature is between about 20° C. and about 500° C.
26. The method of Embodiment No. 20, comprising repeating steps (i) and (ii) to allow generation of oxygen gas and hydrogen gas.
27. The method of Embodiment No. 20, comprising repeating steps (i) and (ii) to allow sequential generation of oxygen gas and hydrogen gas.
28. The method of Embodiment No. 20, comprising repeating steps (i) and (ii) to allow continuous generation of oxygen gas and hydrogen gas.
29. The method of any one of Embodiments No. 20-28, comprising collecting the oxygen gas.
30. The method of Embodiment No. 29, comprising colleting the oxygen gas before step (ii).
31. The method of any one of Embodiments No. 20-30, comprising collecting the OVMO.
32. The method of Embodiment No. 31, comprising colleting the OVMO before step (ii).
33. The method of any one of Embodiments No. 20-32, comprising collecting the hydrogen gas.
34. The method of Embodiment No. 33, comprising collecting the hydrogen gas after step (ii).
35. A method comprising exposing CeO2 to a radiation, to generate an oxygen vacancy CeO₂ (OVMO) and oxygen gas.
36. A method comprising:
   (i) exposing CeO₂ to a radiation, to obtain oxygen vacancy CeO₂ and oxygen gas; and
   (ii) exposing the oxygen vacancy CeO₂ to water vapor to regenerate the CeO₂ and generate hydrogen gas.
37. The method of Embodiment No. 35 or 36, comprising exposing CeO₂ to irradiation, wherein the CeO₂ is at a temperature below 1500° C.
38. The method of Embodiment No. 37, wherein the CeO₂ is at a temperature below 300° C.
39. The method of Embodiment No. 37 or 38, wherein the CeO₂ is at a temperature of between about 20° C. and about 100° C.
40. The method of any one of Embodiments No. 35-39, wherein the radiation is selected from the group consisting of electron beam radiation, alpha radiation, beta radiation, gamma radiation, and UV radiation.
41. The method of Embodiment No. 40, wherein the radiation is radioactive radiation.
42. The method of any one of Embodiments No. 35 to 41, comprising collecting the oxygen gas.
43. The method of any one of Embodiments No. 35 to 42, comprising collecting the oxygen vacancy CeO₂ comprising oxygen vacancy.
44. The method of Embodiment No. 35, comprising exposing the oxygen vacancy CeO₂ to water vapor.
45. The method of Embodiment No. 44, comprising collecting hydrogen gas produced upon exposure of the oxygen vacancy CeO₂ to the water vapor.
46. A reactor comprising a reactor chamber a radiation source, the reactor chamber is configured for holding metal oxide such that upon radiation by the radiation source, the metal oxide particles are exposed to the radiation; and upon the exposure to radiation, gas is generated by the metal oxide.
47. A reactor comprising a reactor chamber including a gas outlet and a radiation source, the reactor chamber is configured for holding metal oxide such that upon radiation by the radiation source, the metal oxide particles are exposed to the radiation; and upon the exposure to radiation, gas is generated by the metal oxide and is being released from the chamber through the gas outlet.
48. The reactor of Embodiment No. 46 or 47, wherein the radiation source is a radioactive source.
49. The reactor of Embodiment No. 46 or 37, wherein the metal oxide is configured to release oxygen atoms upon the exposure to radiation, to generate oxygen gas and a OVMO.
50. The reactor of Embodiment No. 46 or 47, wherein the gas outlet is configured for evacuating oxygen gas from the chamber.
51. The reactor of Embodiment No. 46 or 47, comprising means to collect the OVMO from the chamber.
52. The reactor of any one of Embodiments No. 46-51, comprising a water vapor reservoir.
53. The reactor of Embodiment No. 52, wherein the OVMO is configured to generate hydrogen gas and undergo regeneration to obtain the metal oxide, upon exposure to water vapor from the water vapor reservoir.
54. The reactor of any one of Embodiments No. 52 or 53, wherein the gas outlet is or comprises and hydrogen gas outlet.
55. A reactor comprising a reactor chamber and a radiation source, the reactor chamber is configured for holding metal oxide such that upon radiation by the radiation source, the metal oxide particles are exposed to the radiation; and upon the exposure to radiation, gas is generated by the metal oxide, and wherein the radiation source is a radioactive source.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to better understand the subject matter that is disclosed herein and to exemplify how it may be carried out in practice, embodiments will now be described, by way of non-limiting example only, with reference to the accompanying drawings, in which:

FIG. 1A is a block diagram of an example of a system including a hydrogen generator.

FIG. 1B is a flow diagram 150 of an example of a method of generating hydrogen gas.

FIG. 2 is a diagram of a hydrogen generator with a photo-ionization mechanism for generating hydrogen.

FIG. 3 is a flow diagram of an example of a method of hydrogen generation via photo-ionization.

FIGS. 4A-4C illustrate examples of components for a hydrogen generator with a photo-ionization mechanism for generating hydrogen.

FIG. 5 is a diagram of a hydrogen generator with a chemical looping mechanism for generating hydrogen.

FIG. 6 is a flow diagram of an example of a method of generating hydrogen gas via chemical looping with a metal oxide.

FIG. 7 illustrates a three-dimensional view of an example of a hydrogen generator enclosure.

FIG. 8 is a three-dimensional view of a hydrogen generator in a spent nuclear fuel (SNF) storage cask.

FIGS. 9A-9D illustrate three-dimensional views of the spent nuclear fuel (SNF) storage cask in different positions during operation.

FIGS. 10A-10D are exemplary images of CeO₂ and oxygen vacancy CeO₂ in accordance with some embodiments, the arrow indicates changes in color.

FIGS. 11A-11D are exemplary images of CeO₂ and oxygen vacancy CeO₂ in accordance with some embodiments.

FIGS. 12A-12C are exemplary images of CeO₂ and oxygen vacancy CeO₂ in accordance with some embodiments.

FIGS. 13A-13B are exemplary set up for generation of oxygen gas.

FIG. 14 is a graph showing changes in the metal oxide mass.

FIG. 15 is an exemplary schematic representation of the experimental setting for oxygen generation.

FIG. 16 is an exemplary schematic representation of the experimental setting for oxygen generation.

FIGS. 17A-17B are exemplary schematic representation of an exemplary system for hydrogen release.

FIGS. 18A-18B are graphs showing hydrogen level in control experiments.

FIGS. 19A-19C are exemplary images of CeO₂ and oxygen vacancy CeO₂ in accordance with some embodiments.

FIG. 20 is a graph showing hydrogen generation.

FIG. 21 is a graph showing hydrogen generation.

### DETAILED DESCRIPTION OF EMBODIMENTS

The following refer to exemplary methods and reactors.

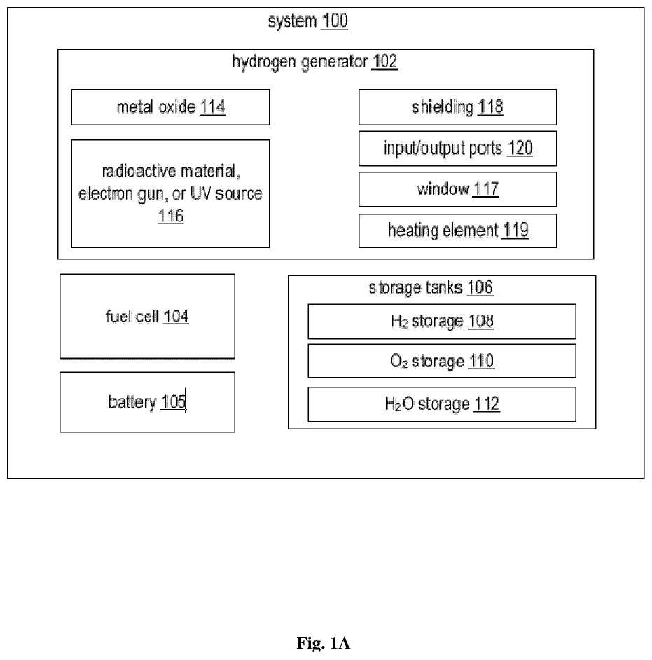

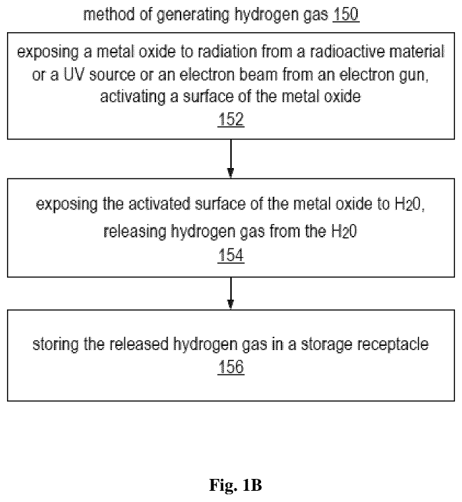

FIG. 1A is a block diagram of an example of a system (may be part of the reactor described herein) including a hydrogen generator. The system 100 includes a hydrogen generator 102 for generating or producing hydrogen and storage tanks 106 for storing the input and output materials of the system 100. The hydrogen generator includes a metal oxide 114. As noted herein, the present disclosure is not limited to a specific metal oxide. Non-limiting examples of metal oxide include ZrO2 (zirconia), CeO2 (ceria), FeO (ferrous oxide), NiO (nickel (II) oxide) and TiO (Titanium(II) Oxide). In one example, the metal oxide 114 is in the form of a metal oxide powder. In another example, the metal oxide 114 is in the form of a coating (e.g., a coating on a substrate). The metal oxide 114 can be in other forms, for example, pellets, “slurry” in water surroundings or another form.

The system 100 also includes a source of radiation or an electron beam generator. The energy source can include, for example, a radioactive material, an electron gun, or a UV source 116. In an example in which the energy source is a radioactive material, the radioactive material can be any radioactive material that generates radiation (Alpha-, Beta- and/or Gamma-radiation) with sufficient energy to remove electrons or oxygen from the surface of the metal oxide 114. Examples of radioactive material include spent nuclear fuel, Co-60, Sr-90, Cs-137, Cs-135, Mo-99, or any other radioactive material.

As noted above, the radiation such the one released from the radioactive material can include one or more of alpha radiation, beta radiation, or gamma radiation. Alpha, beta, and gamma radiation each differ in mass, charge, energy and consequently, the penetration depth through a medium, and current commercial applications.

The radioactive material can be internal or external to the system 100. For example, the radioactive material can be external but coupled via a window 117 to the hydrogen generator 102 to enable radiation from the radioactive material to enter a chamber housing the metal oxide 114. In another example, the radioactive material is housed within the hydrogen generator (e.g., in the same chamber as the metal oxide).

Whether or not the radioactive material is internal or external from the hydrogen generator 102, in one example, the radioactive material is surrounded by shielding 118. In an example where the radioactive material is within the hydrogen generator 102, the hydrogen generator may include additional shielding surrounding the hydrogen generator 102. In one such example, the shielding around the hydrogen generator is not as thick as (i.e., thinner than) the shielding surrounding the radioactive material.

Similarly, in examples where the energy source is an electron gun or a UV source (e.g., UV lamp or other UV source), the electron gun or UV source can be located internally or externally from the hydrogen generator 102. In an example where the UV source or the electron gun are located external from the hydrogen generator, the apparatuses generating the UV radiation or electron beam can be coupled with the hydrogen generator via a window 117. An optional heating element 119 may be included to speed up the reactions and increase the rate of hydrogen production.

The hydrogen generator 102 also includes input ports and output ports 120 for introducing water or water vapor into the hydrogen generator and removing oxygen and hydrogen from the hydrogen generator 102. In one example, the input/output ports 120 include valves to enable the ports 120 to be opened or closed. In one example, the hydrogen generator 102 includes separate ports for water or water vapor (input), oxygen (output), and hydrogen (output). In another example, the hydrogen generator 102 includes one input port for water or water vapor, and one output port for gas (either hydrogen or oxygen, depending on the time that the port is used to extract gas from the chamber of the hydrogen generator 102).

In one example, the input/output ports 120 are coupled with storage tanks or receptacles 106. For example, an H2O port is coupled with an H2O storage tank 112, which stores H2O (e.g., water). In one example, gas ports (or individual hydrogen and oxygen ports) are coupled with H2 storage 108 and O2 storage 110. The H2 storage 108 stores hydrogen output from the hydrogen generator, and the O2 storage 110 stores oxygen output from the hydrogen generator 102. The system 100 may also include a fuel cell 104 to use hydrogen generated by the hydrogen generator 102 to generate electricity, which can either be stored in a battery 105 or output to the electrical grid.

FIG. 1B is a flow diagram 150 of an example of a method of generating hydrogen gas. The method 150 may be performed with a hydrogen generator, such as the hydrogen generator 102 of FIG. 1A. The method 150 involves exposing a metal oxide to radiation from a radioactive material or a UV source or an electron beam from an electron gun, at block 152. For example, referring to FIG. 1A, the method involves exposing the metal oxide 114 to radiation or an electron beam from the radioactive material, electron gun, or UV source 116. Exposing the metal oxide to radiation or an electron beam activates the surface of the metal oxide. For example, the radiation or electron beam causes the metal oxide to release or lose electrons or oxygen molecules.

Referring again to FIG. 1B, the method 150 involves exposing the activated surface of the metal oxide to H2O (water or water vapor), at block 154. For example, referring to FIG. 1A, the metal oxide 114 is exposed to H2O input to the hydrogen generator 102 via an input port 120 from the H2O storage receptacle 112. In one example, the activated metal oxide acts as a catalyst, reacting with the H2O introduced into the hydrogen generator, splitting the H2O and releasing hydrogen.

Referring again to FIG. 1B, the released hydrogen is then stored in a storage receptacle, at block 156. For example, referring to FIG. 1A, the hydrogen gas is extracted from the hydrogen generator 102 via an output port 120 and stored in the hydrogen storage receptacle 108. The hydrogen gas can then be transported or used on site to generate electricity.

FIG. 2 is a diagram of a hydrogen generator with a photo-ionization mechanism for generating hydrogen. The hydrogen generator 200 includes a chamber 201. The chamber 201 is separated by a membrane 208 and a barrier support structure 216. In one example, the membrane 208 is a proton membrane. An anode 204 and cathode 206 generate an electrical field to attract electrons released from the metal oxide (upon irradiation) and protons released from the water molecules following the metal oxide ion interaction with the water molecule. The membrane 208 and barrier 216, in combination with the electrical field generated with the electrodes 204 and 206, enable separation of the hydrogen and oxygen after splitting the water to prevent recombination.

The hydrogen generator 200 includes a metal oxide 210 in the chamber 201. In one example, the metal oxide 210 is a metal oxide powder. The chamber 201 has an input port 220 to input water into the chamber 201, and output ports 218 and 222 to output oxygen gas and hydrogen gas, respectively. In one example, the hydrogen generator is operated with the metal oxide in water, as shown by the water level line 214. Hydrogen and oxygen gas released during operation of the hydrogen generator rise above the water line 214 and can be extracted from the chamber 201 via the ports 218 and 222.

In the example illustrated in FIG. 2, the radiation or electron beam source 211 is external to the chamber 201. Radiation or an electron beam 202 from the source 211 is directed at the metal oxide in the chamber 201 via a window 212. In one example, the window 212 is glass, quartz, magnesium fluoride (MgF) or another material permitting transmission of radiation or an electron beam into the chamber 201. In one example in which a radioactive material is used, shielding 224 surrounds the hydrogen generator 200. Additional shielding may surround the radioactive material.

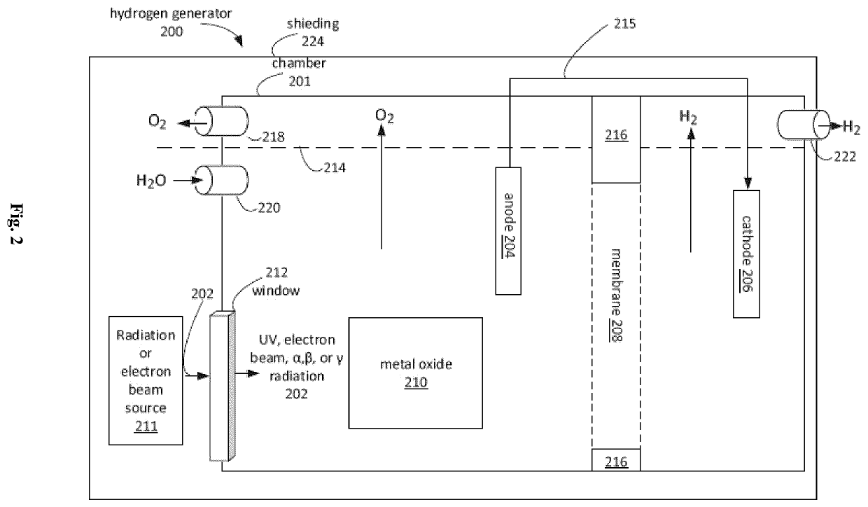

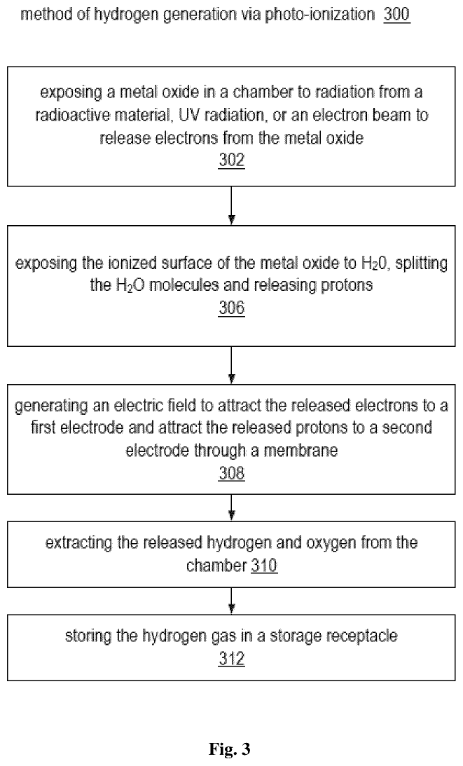

FIG. 3 is a flow diagram of an example of a method of hydrogen generation via photo-ionization. The method 300 may be performed with a hydrogen generator such as the hydrogen generator 200 of FIG. 2.

The method 300 begins with exposing a metal oxide in a chamber to radiation from a radioactive material, UV radiation, or an electron beam, at block 302. For example, referring to FIG. 2, the metal oxide 210 is irradiated with radiation or with an electron beam from a radiation or electron beam source 211 (e.g., from a radioactive or UV source or an electron gun). In one example, the metal oxide 210 is a metal oxide powder in water, forming a slurry. In one example, when the metal oxide is irradiated, the metal oxide releases electrons resulting in the metal oxide having an ionized surface.

Referring again to FIG. 3, the ionized surface of the metal oxide is exposed to water, splitting the H₂O molecules and releasing protons from the H₂O molecules, at block 306. The method also involves generating an external electric field to attract the released electrons to a first electrode and the released protons to a second electrode through a membrane, at block 308. For example, referring to FIG. 2, the radiation or electron beam ionizes the metal oxide 210 to release an electron and form a cation. The electron will be drawn to the anode 204 while the cation will attack the water to release a proton that will move to other side of the cell to the cathode 206 through the proton membrane 208. The process can be represented by equation (III) noted above.

Referring again to FIG. 3, the released hydrogen and oxygen can then be extracted from, the chamber, at block 310. For example, referring to FIG. 2, the oxygen that accumulated above the water line 214 on the one side of the barrier 216 can be removed via the port 218. Similarly, the hydrogen gas that accumulated on the other side of the barrier 216 can be removed via the port 222. The gases can be pumped out of the chamber 201; however, the gases can be removed from the chamber 201 without pumping by opening the valves/ports 218 and 222 due to the positive pressure build up in the chamber 201.

Referring again to FIG. 3, the hydrogen gas can then be stored in a storage receptacle, at block 312.

Note that the changes to the metal oxide are reversed during the process, so that the same metal oxide can be used over and over again to perform the hydrogen generation process 300.

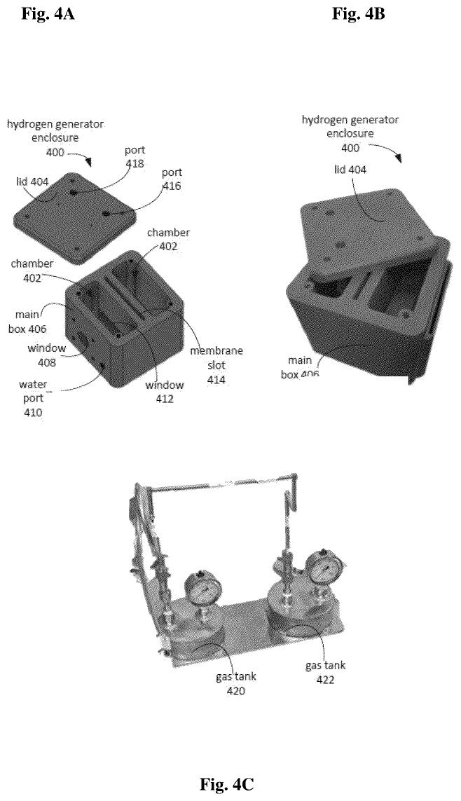

FIGS. 4A-4C illustrate examples of components for a hydrogen generator with a photo-ionization mechanism for generating hydrogen. FIGS. 4A and 4B illustrate three-dimensional views of examples of a hydrogen generator enclosure 400. The enclosure 400 is an example of an enclosure for a hydrogen generator such as the generator 200 of FIG. 2. The enclosure 400 includes a main box 406 with hollow areas to form the sealed chamber 402 when closed with the lid 404. In the example illustrated in FIGS. 4A and 4B, the main box 406 includes a slot 414 for a proton membrane and a window 412 for exposing the membrane to enable separation of the released protons: electrons will be transferred from the anode 204 to the cathode 206 (FIG. 2) through metal conductive wire 215 that connect both electrodes.

The main box 406 also includes a water port 410 for introducing water into the chamber 402 and a window 408 for transmitting radiation or electron beams from an external source. The lid 404 includes two openings or ports 418 and 416 to allow for extraction of the oxygen and hydrogen gases released during operation of the hydrogen generator. FIG. 4C illustrates the separate gas tanks 420 and 422 for storing the released hydrogen and oxygen.

FIG. 5 is a diagram of a hydrogen generator with a chemical looping mechanism for generating hydrogen. Similar to the hydrogen generator 200 of FIG. 2, the hydrogen generator 500 of FIG. 5 includes a chamber 501. However, unlike the chamber 201 of FIG. 2, the chamber 501 is not separated by a membrane and barrier. Because in the chemical looping mechanism used by the hydrogen generator 500 of FIG. 5, the oxygen and hydrogen are released at separate times, making it unnecessary to separate the two gases with a barrier inside the chamber.

The hydrogen generator 500 includes a metal oxide 510 in the chamber 501. The metal oxide 510 can be the same as, or similar to, the metal oxide described above with respect to FIG. 2. For example, the metal oxide 510 can be a metal oxide powder. The chamber 501 has an input port 520 to input water vapor into the chamber 501, and output ports 518 and 522 to output oxygen gas and hydrogen gas, respectively. However, in another example, a single output port may be used to output both hydrogen and oxygen gases.

In the example illustrated in FIG. 5, the radiation or electron beam source 511 is external to the chamber 501. Radiation or an electron beam 502 from the source 511 is directed at the metal oxide in the chamber 501 via a window 512. In one example, the window 512 can have the same or similar properties of the window 212 of FIG. 2, discussed above. In one example in which a radioactive material is used, shielding 524 surrounds the hydrogen generator 500. Additional shielding may surround the radioactive material.

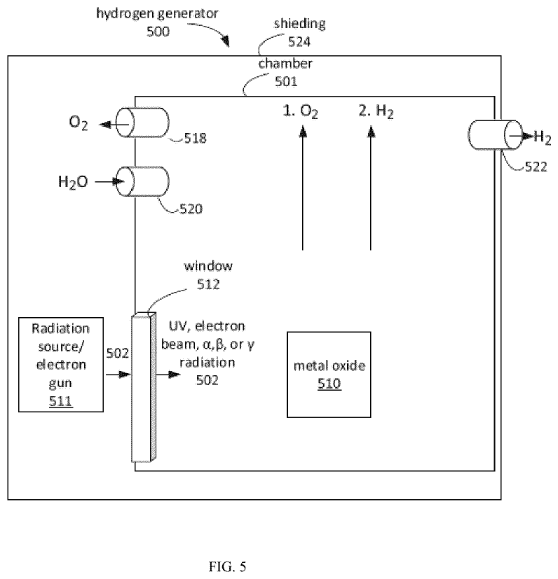

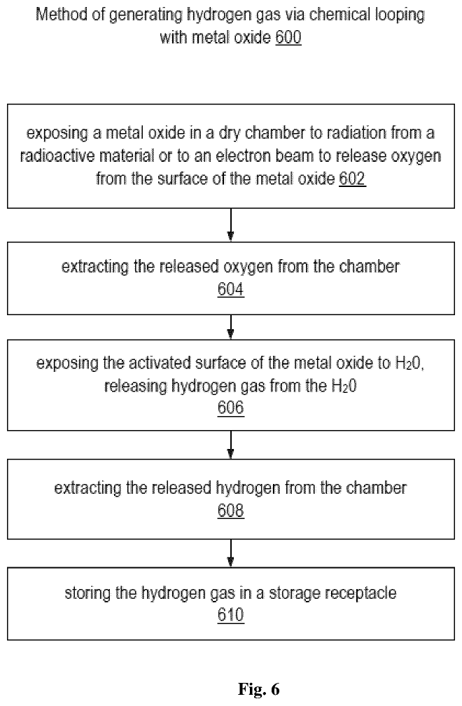

FIG. 6 is a flow diagram of an example of a method of generating hydrogen gas via chemical looping with a metal oxide. The method 600 may be performed by a hydrogen generator, such as the hydrogen generator 500 of FIG. 5.

The method 600 begins with exposing a metal oxide in a dry chamber to radiation from a radioactive material or UV source or to an electron beam from an electron gun to release oxygen from the surface of the metal oxide, at block 602. The released oxygen is then extracted from the chamber, at block 604. For example, referring to FIG. 5, the metal oxide 510 is irradiated with radiation or an electron beam 502, releasing O₂. The oxygen can then be removed via the output port or valve 518. In one example, the oxygen is pumped from the chamber 501 to completely evacuate the chamber 501. In other examples, the oxygen gas is removed using the pressure build-up from the release of oxygen gas by opening the valve 518.

Referring again to FIG. 6, The activated metal oxide is then exposed to water vapor, at block 606. For example, referring to FIG. 5, water vapor is introduced to the chamber 501 via the port 520. Exposure of the activated metal oxide 510 to water vapor causes the water vapor to release hydrogen gas. The oxygen from the water vapor recombines with the metal oxide's surface, splitting the water molecules and releasing the hydrogen. The general process can be represented by equation (III) shown above.

Referring again to FIG. 6, after releasing the hydrogen gas, the released hydrogen is extracted from the chamber, at block 608. For example, referring to FIG. 5, the hydrogen gas can be extracted via port 522 by pumping or opening the valve and utilizing the pressure build-up from the released gas. The hydrogen gas is then stored in a storage receptacle, at block 610.

Note that the changes to the metal oxide are reversed during the process, so that the same metal oxide can be used over and over again to perform the hydrogen generation process 600. For example, irradiating the metal oxide causes it to release oxygen, which results in oxygen holes or gaps in the metal oxide (resulting in the activated catalyst). After adding the water vapor, the oxygen holes or gaps take the oxygen from the water vapor, returning the metal oxide to its original form and release hydrogen.

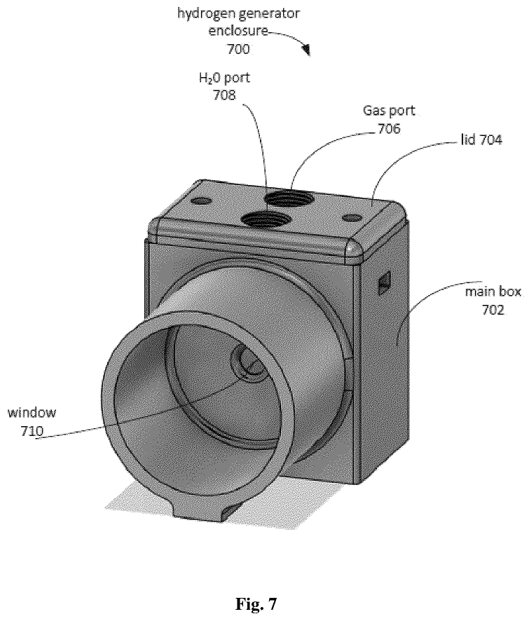

FIG. 7 illustrates a three-dimensional view of an example of a hydrogen generator enclosure 700. The enclosure 700 is an example of an enclosure for a hydrogen generator such as the generator 500 of FIG. 5. The enclosure 700 includes a main box 702 with a hollow interior to form a sealed chamber when closed with the lid 704.

The main box 702 also includes a window 710 for transmitting radiation or electron beams from an external source. The lid 704 includes an opening or H₂O port 708 for introducing water vapor into the chamber and an opening or gas port 706 to allow for extraction of the oxygen and hydrogen gases released during operation of the hydrogen generator. The hydrogen generator enclosure 700 can be coupled with separate gas tanks for storing the released hydrogen and oxygen, as shown in FIG. 4C.

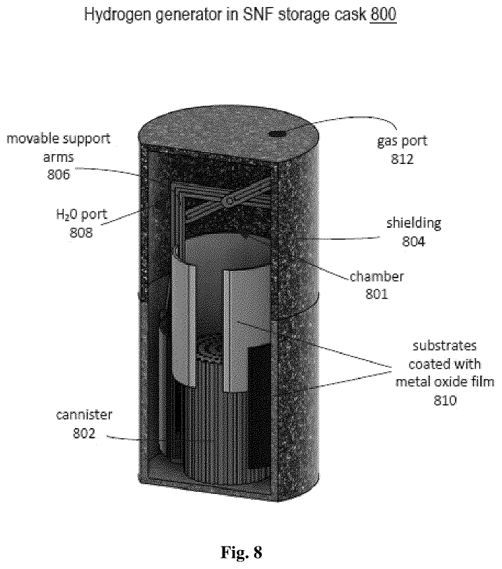

FIG. 8 is a three-dimensional view of a hydrogen generator in a spent nuclear fuel (SNF) storage cask 800. Currently, there are no known uses for spent nuclear fuel, and spent nuclear fuel casks are used only for safe storage of spent nuclear fuel. In contrast, a spent nuclear fuel container with a hydrogen generator can not only safely store the spent nuclear fuel, but also use the spent nuclear fuel as a free energy source to provide high power (as a function of the material mass) that lasts for years with very low maintenance.

The SNF storage cask 800 includes a spent nuclear fuel cannister 802 in a chamber 801 surrounded by shielding 804. Movable support arms 806 are coupled with metal oxide coated substrates 810 in the chamber 801. The movable support arms alternately move the metal oxide coated substrates 810 proximate to the nuclear fuel cannister 802 (to expose the metal oxide to radiation from the cannister 802) and away from the nuclear fuel cannister 802 (to bring the activated metal oxide into contact with water vapor that is input into the system via a port 808). The released oxygen and hydrogen can be removed from the cask via one or more gas ports, such as the gas port 812.

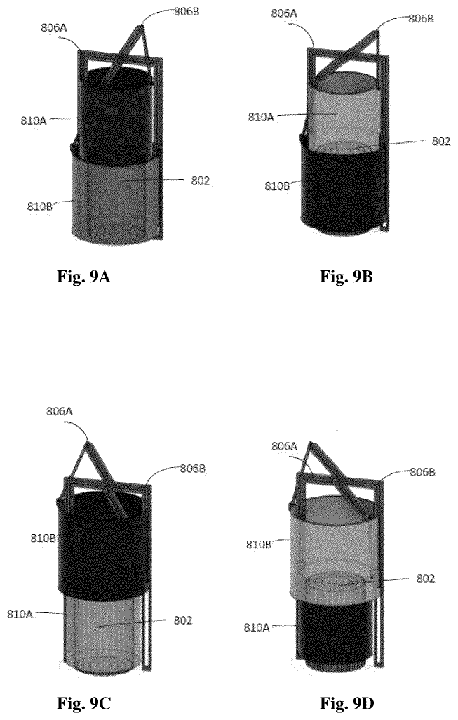

FIGS. 9A-9D illustrate three-dimensional views of the spent nuclear fuel (SNF) storage cask 800 in different positions during operation. In the example of FIGS. 9A-9D, the metal oxide used for hydrogen generation is a metal oxide coating or film on two cylindrical substrates 810A and 810B around the spent nuclear fuel cannister 802. In the example of FIGS. 9A-9D, the system includes an inner metal oxide coated substrate 810A and an outer metal oxide coated substrate 810B. The inner substrate 810A has a smaller diameter and can pass through the outer substrate 810B as the substrates are moved into positions proximate to and away from the cannister 802 by the support arms 806A and 806B.

FIG. 9A shows the metal oxide coated substrate 810B in a position near or proximate to the cannister 802 and the other metal oxide coated substrate 810A in a position away or distant from the cannister 802. The metal oxide coated substrate 810B that is adjacent to the cannister 802 is shown having a light color (yellow) indicating that the metal oxide has not been activated (e.g., has not released oxygen due to irradiation from the spent nuclear fuel cannister 802). The metal oxide coated substrate 810A that is not adjacent to the cannister 802 is shown having a darker color (black) indicating that the metal oxide has been activated, and therefore has moved away from the cannister 802 towards water vapor introduced into the system to release hydrogen from the activated surface of the metal oxide coated substrate 810A.

FIG. 9B shows the metal oxide coated substrates 810A and 810B in the same positions as in FIG. 9A but at a later point in time. The metal oxide coated substrate 810B that is adjacent to the cannister 802 is shown in FIG. 9B as having a darker color (black) indicating that the metal oxide has been activated (e.g., has released oxygen due to irradiation from the spent nuclear fuel cannister 802). The metal oxide coated substrate 810A that is not adjacent to the cannister 802 is shown having a lighter color (yellow) indicating that the oxygen from the water vapor has recombined with the activated metal oxide, returning the metal oxide to its original state. The released oxygen and hydrogen gases can then be removed from the system.

FIG. 9C shows the metal oxide coated substrates 810A and 810B moved into opposite positions after releasing hydrogen and oxygen, respectively. The movable support arms moved the metal oxide 810B up away from the cannister 802, and the metal oxide 810A down towards the cannister 802.

FIG. 9D shows the metal oxide coated substrates 810A and 810B in the same positions as in FIG. 9C but at a later point in time. Therefore, the metal oxide coated substrate 810A that is adjacent to the cannister 802 is shown in FIG. 9D as having a darker color (black) indicating that the metal oxide has been activated. The metal oxide coated substrate 810B that is not adjacent to the cannister 802 is shown in FIG. 9D as having a lighter color (yellow) indicating that the oxygen from the water vapor has recombined with the activated metal oxide, returning the metal oxide to its original state. The released oxygen and hydrogen gases can again be removed from the system. Thus, the changes to the metal oxide 810A and 810B is reversible, and the process can continue with minimal intervention. Additionally, in one example, the moveable arms can alternately move the metal oxides towards and away from the cannister 802 because once the metal oxide releases oxygen, it becomes lighter, causing the metal oxide to automatically rise. However, in other examples, an external power supply can be provided.

Although not shown in FIGS. 9A-9D, the system can include a barrier or separation between the upper and lower levels (e.g., the region near the cannister 802 and the region away from the cannister where the water vapor is introduced) to prevent recombination of the released hydrogen and oxygen. In other examples, a single metal-oxide coated substrate, or more than two metal-oxide coated substrates can be used.

Flow diagrams as illustrated herein provide examples of sequences of various process actions. The flow diagrams can indicate operations to be executed by a software or firmware routine, as well as physical operations. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted: thus, not all implementations will perform all actions.

### NON-LIMITING EXAMPLES

### Example 1: Testing Reversibility of Metal Oxide

### Materials

Thin ceria pellets were used. as nano powder—up to 100 nm and as Micro powder—4-5 μm.

### Methods:

Oxygen generation was tested with CeO₂ (metal oxide) and electron gun (to simulate beta radiation) as a power source as well as in vacuum

As the cerium metal has a naturally black-blue color, a change in color from the white color of CeO₂ suggested that discoloration was associated with release of all (both) oxygen atoms from each one of the metal oxide molecules.

### Example 1A: CeO₂ Pellet

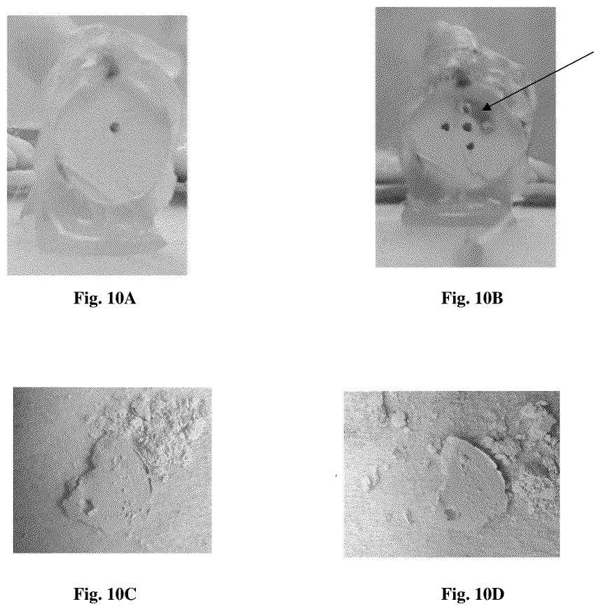

A 3 mm thick pellet of CeO₂ was prepared, with a uniform and flat anode behind it. Irradiation with CeO₂ with an electron beam from an electron gun at about 300 kWatts for a few minutes resulted in change in color shown as blackening of CeO₂ as can be seen in FIG. 10A and FIG. 10B showing the CeO₂ before and after the irradiation, respectively (arrows in FIG. 10B point to the change in color and formation of blackening of CeO₂).

The pellet formed after irradiation (FIG. 10C) was kept in air surrounding and after 2 days, the original color was observed (FIG. 10D), suggesting that oxygen was reabsorbed by spontaneous oxygen (air) diffusion in room temperature.

### Example 1B: Thin CeO₂ Film on a Mesh Anode

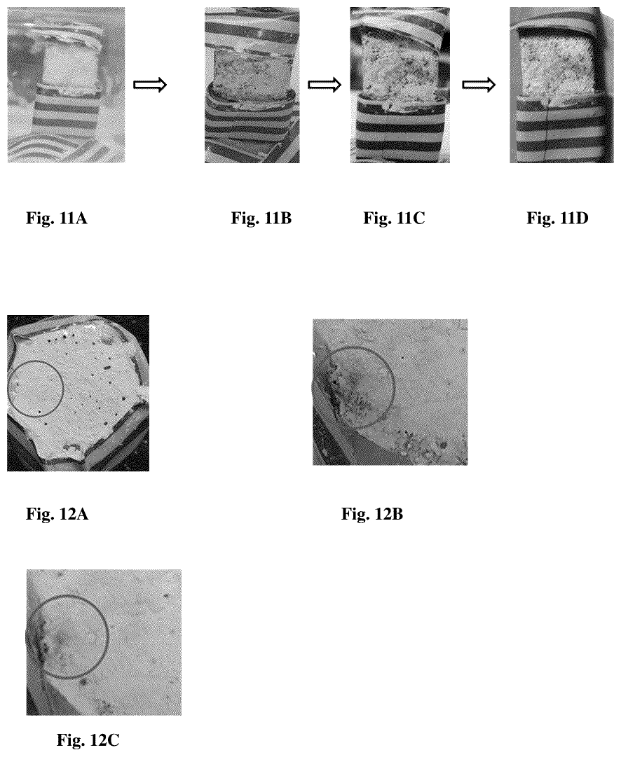

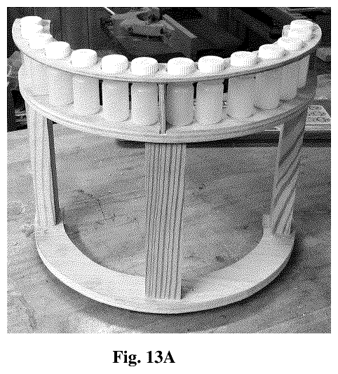

A thin coating of CeO₂ was prepared on a tight mesh anode and tested in vacuum and air surroundings. The direct arcing produced black-blue colors on the coating as can be seen from FIG. 11A and FIG. 11B, showing CeO₂ before and after irradiation, respectively.

After about 2-3 hours, the CeO₂ coating started regaining its yellow color back Upon additional radiation of the CeO_{2,} the black-blue colors appeared again (FIG. 11C) and disappeared after several days and the original color was observed (FIG. 11D).

### Example 1C: Thin CeO₂ Film on a Mesh Aluminum Foil

A few millimeters coating of CeO₂ was prepared on a thin aluminum foil, patterned and tested in vacuum surroundings (FIG. 12A, red circle indicate the visual change in the color in all images). Both direct arcing and electron scattering were produced for 35 minutes and afterwards, the CeO₂ film changed the color to more black-blue colors (FIG. 12B).

Hot water was then added in two small cups to the vacuum chamber and air was pumped out to create a humid environment in the chamber. After about 30 minutes the film started regaining its white-yellow color back as can be seen in FIG. 12C, suggesting that oxygen atoms were reabsorbed onto the CeO₂ film.

Upon impact (electron beam through CeO₂ to anode) the color of the beam is purple-blue, changes in the CeO₂ were observed.

Once water vapor was pushed through the ceria, a change in color was observed within minutes, suggesting that re-combined oxygen originates from the water molecules, and release hydrogen. The recombination with oxygen from the air took 2 days, therefore this cannot be the reason for the change in color.

Hence based on these visual findings, chemical looping was suggested including a two-step mechanism. The first step involves electron-beam that is used to remove the oxygen from the CeO₂ and in the second step, the “oxygen vacancies” in the CeO₂ recombine with oxygen from the water, essentially splitting the water, and release hydrogen.

### Example 2: Testing Changes in Meal Oxide Mass

### Materials and Methods

15 mL sample bottles comprising about 22 gram of CeO₂ Micro Powder (5 μm) were exposed to a known Co-60 source (1.7 Mrad/s) for various durations (various fluences) as detailed below. Experiments conducted with the University of Maryland Co-60 Source.

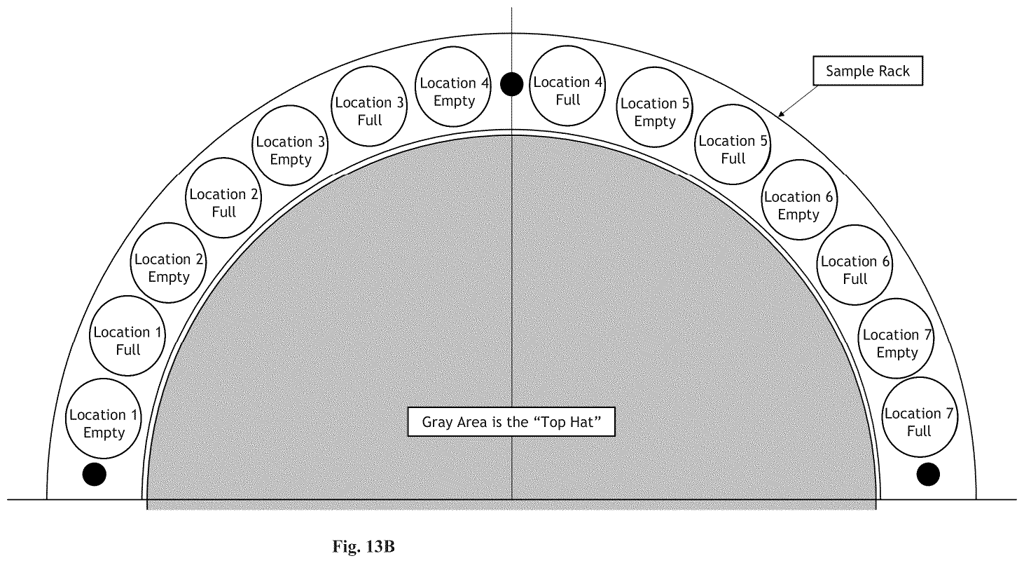

To make sure that each of the sample bottles are at the same radius and at the axial center of the cobalt pencils a rack was fabricated. The rack is designed to fit up against the outside radius of the stainless steel “top hat” without interference with the mechanism used to raise and lower the source into and out of the same. The rack includes adjustable feet to allow leveling of the rack and to place the centerline of the bottles at the axial center of the cobalt pencils when raised to the top position inside the “top hat”. The rack positions the bottle at a radius of 5.88 inches from the center of the “top hat”. The figure below is a photo of the fabricated rack. An exemplary experimental setting is shown in FIGS. 13A and 13B.

The experiment included the following steps: Bottles (30) were sterilized, and the weigh of each bottle was recorded. Then, 15 bottles were filled with about 22 grams of Ceria Oxide (CeO₂) powder and the weight of each bottle with CeO₂ was recorded. From these measurements, the weight of CeO₂ in each bottle was calculated. The samples were placed in the racks and positioned around the Co-60 source. As can be seen in FIG. 13B, adjacent to each bottle with CeO₂, an empty bottle was placed.

The samples were irradiated for prescribed durations. After irradiation, the bottles were removed, and the irradiation duration was recorded. Then, each bottle (without the caps) was weighed to note the post irradiation weight.

The difference between the weight prior to irradiation and post irradiation was calculated to determine the reduction in weight due to the irradiation.

Table 1 shows the irradiation time for each sample combination (empty bottle and bottle with ˜22 grams of ceria pairs) and location in the rack.

TABLE 1
Irradiation time for the different samples

| | | Irradiation |
|---|---|---|
| Location | Sample | Time (hrs) |
| 1 | 1 | 24 |
| 2 | 2 | 48 |
| 3 | 3 | 72 |
| 4 | 4 | 96 |
| 5 | 5 | 120 |
| 6 | 6 | 192 |
| 7 | 7 | 312 |
| 1 | 8 | 168 |
| 2 | 9 | 240 |
| 3 | 10 | 216 |
| 4 | 11 | 192 |
| 5 | 12 | 144 |
| 6 | 13 | 96 |
| 1 | 14 | 96 |
| 5 | 15 | 48 |

Afterwards, the weight loss for each sample was measured to calculate the weight loss due oxygen vacancies created in the Ceria.

### Results

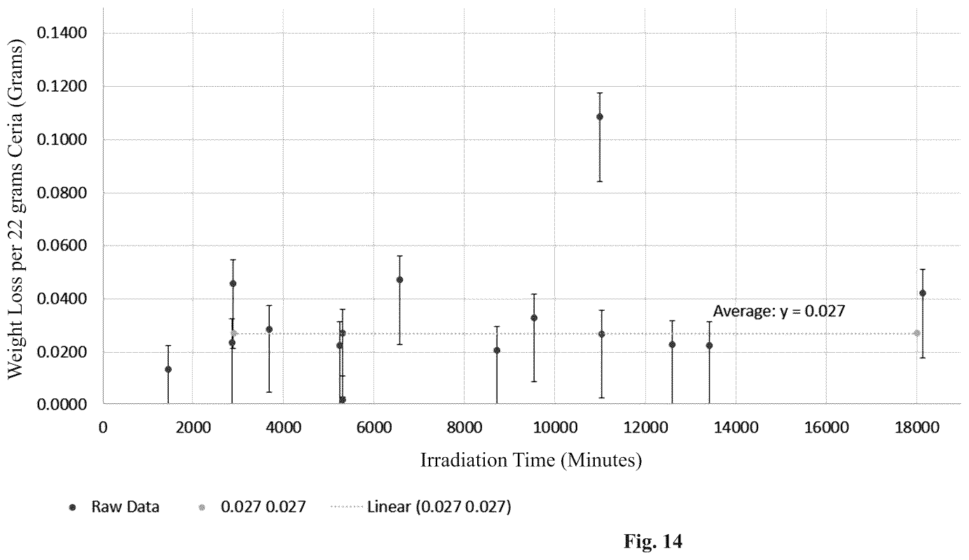

The CeO₂ was weighted before and after radiation and a reduction in CeO₂ mass and a reduction of 0.0005 mg (5 micro grams) was observed after radiation. This suggest that upon irradiation, oxygen atoms are released from CeO₂, resulting in a reduced mass. FIG. 14 shows the mass reduction as a function of irradiation time.

### Example 3: Generation of Oxygen Gas and Hydrogen Gas

### Instruments

Two power systems were used: (i) High power electron beam (simulating beta radiation)—measured dose of 2 Gy per pulse; 100 pulses per sec (University of Maryland, USA) (ii) a Co⁶⁰ source that emits gamma rays with measured dose of 1.7 Mrad/s (University of Maryland, USA).

### Irradiation

As mentioned above, two power sources, for each a separate set up, as demonstrated schematically below. In both cases the metal oxide (MO) was irradiated at ambient conditions (atmospheric pressure and room temperature).

### E-Beam

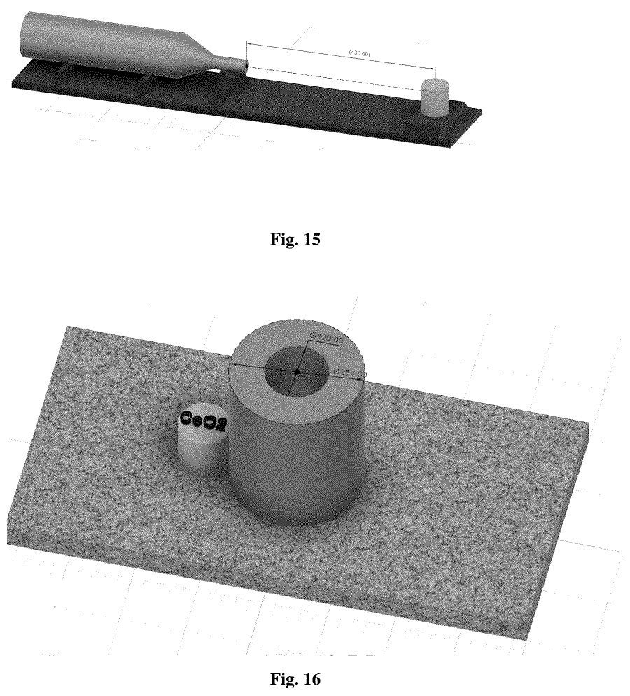

Electron beam—direct irradiation of the samples, was used to simulate beta radiation in terms of interactions (beta radioisotope will emit electrons isotropically unlike the beam). A schematic representation of the experimental setting is shown in FIG. 15.

### Gamma Radiation Source—Co⁶⁰

2 kg of Ceria powder was placed in a jar against the outer diameter of the source's cylinder. Source diameter=254 mm→I @ r=127 mm=0.7 MRad/hr. A schematic representation of the experimental setting is shown in FIG. 16.

### Hydrogen Release Measurements

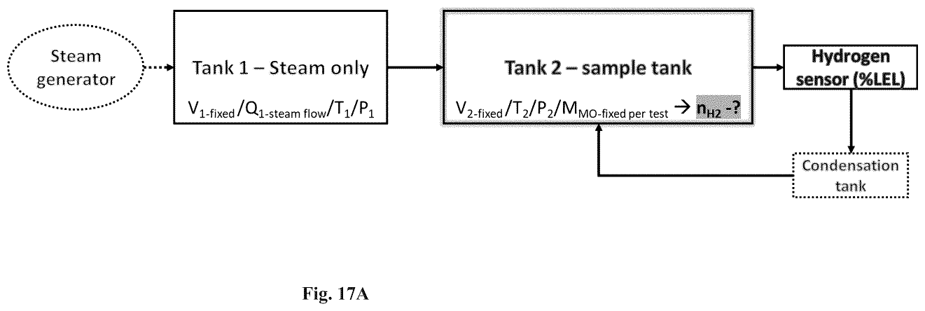

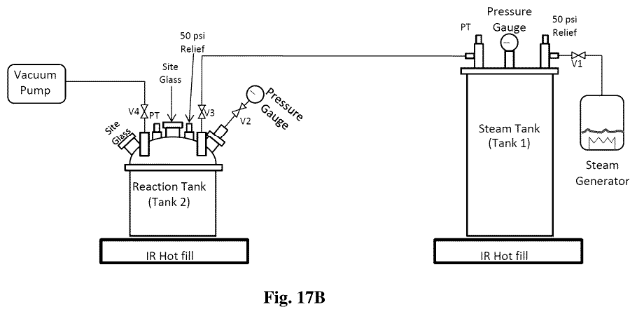

FIGS. 17A and 17B show schematic representation of an exemplary system for hydrogen release, with P represents pressure; T—temperature; V—volume; Q—volumetric flow; M—mass; LEL—Lower Explosive Limit for hydrogen.

On each test, the pressure and temperature were directly measured in both tanks, in addition to the hydrogen LEL % in tank 2.

Since the pressure and temperature are not constant with time, e the actual amount of hydrogen from the LEL %, P2 and T2 at any given time was calculated.

The hydrogen amount (mols) calculation was as follows (assuming ideal gas in both tanks):

$$P V = n R T \to {n}_{{H}_{2}} = \frac{{P}_{2} {V}_{{H}_{2}}}{R {T}_{2}} \\ R = gas constant = 0.082 \frac{L \cdot atm}{mol \cdot K} = 0.082 \frac{L \cdot atm}{mol \cdot K} \cdot \frac{14.7 psi}{1 atm} = 1.2054 \frac{L \cdot psi}{mol \cdot K} \qquad 1$$

$${V}_{{H}_{2}} = \frac{\% {LEL}_{measured}}{100} \cdot \frac{{LEL}_{{H}_{2}}}{100} \cdot {V}_{2} = \frac{\% {LEL}_{measured}}{100} \cdot \frac{4}{100} \cdot 2.6 = 0.00104 \cdot \% {LEL}_{measured} \\ {n}_{{H}_{2}} = \frac{{P}_{2 ( p s i )} \cdot {V}_{{H}_{2} ( L )}}{R \cdot {T}_{2 ( K )}} = \frac{{P}_{2 ( p s i )} \cdot 000104 \cdot \% {LEL}_{measured}}{1 \text{.2054} \cdot {T}_{2 ( K )}} = 8.63 \times 1 {0}^{- 4} \times \frac{{P}_{2 ( psi )} \% {LEL}_{measured}}{{T}_{2 ( K )}} \qquad 2$$

In order to measure the actual formation of hydrogen in the given sensor, initially the test with no MO (Ceria) presence was performed and the max % LEL was determined as “% LEL ref” in the stable region (marked in red dashed line in the charts below). Later the value was reduced from the measured % LEL and defined the outcome value as % LEL-real.

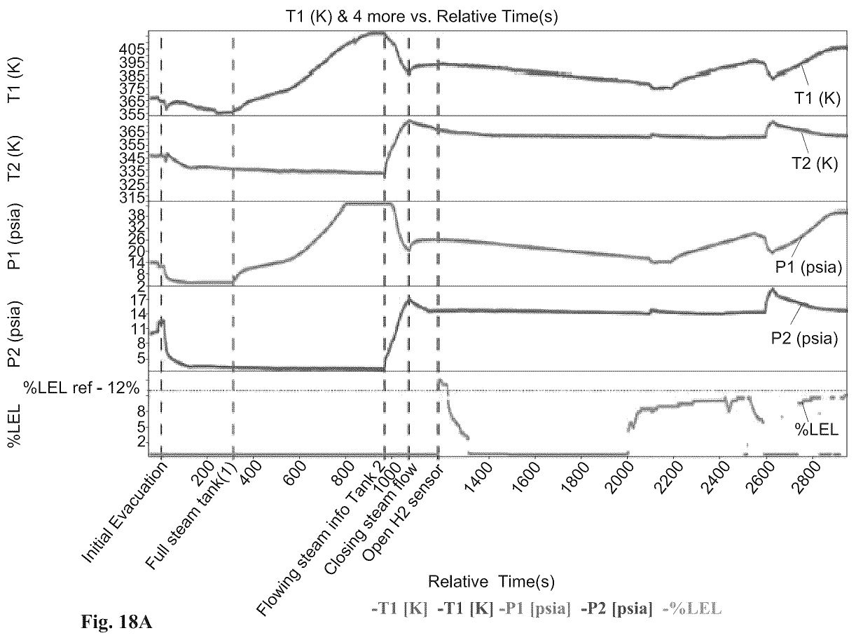

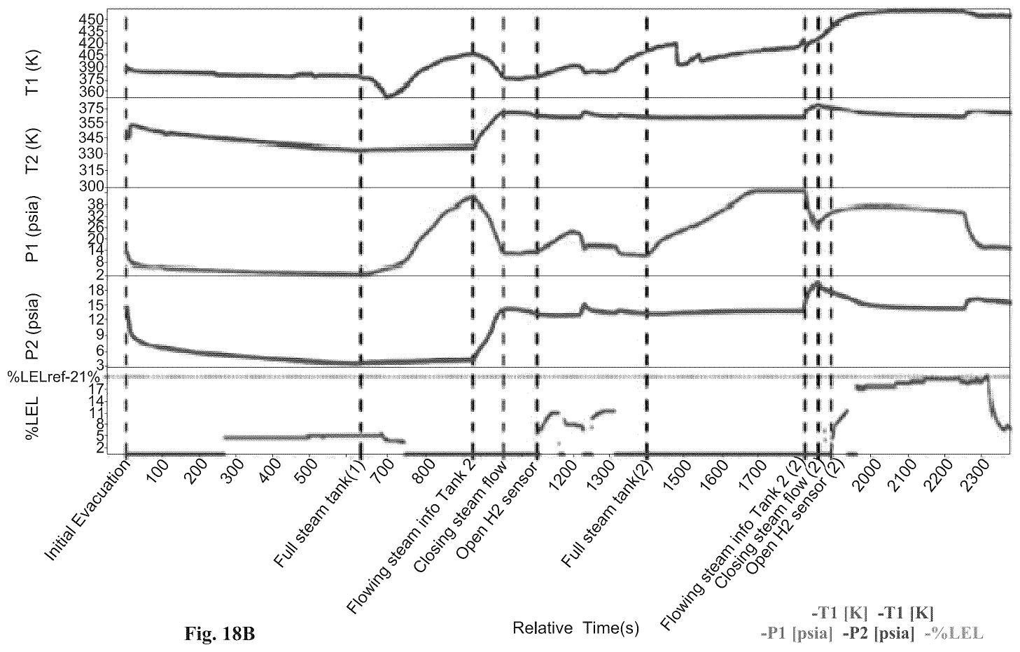

FIGS. 18A and 18B show hydrogen control measurements with % LEL ref was 12% and 21%, receptively.

### Results and Discussion

The mechanism was evaluated with CeO₂ (Ceria) as metal oxide and two types of power sources; high power electron beam (simulating beta radiation) and Co⁶⁰ that emits gamma rays.

### Example 3A: Nano-Ceria With 150 Minutes Electron Beam Irradiation (E-Beam)

The method in this example included two steps. The first step irradiation and oxygen release and the second step hydrogen release.

### Irradiation and Oxygen Release

As detailed above, 251.3 g of Ceria (CeO₂) was placed in a jar at 43 cm from the barrel to middle of the jar and the beam Irradiation is 100 pulses/sec with 2 Gy/pulse.

The sample was irradiated with 100 pulses/sec (2 Gy/pulse) for 30 min×5/6 cycles (total of 150/180 min).

Every 30 min, the temperature was measured, and the sample was manually stirred.

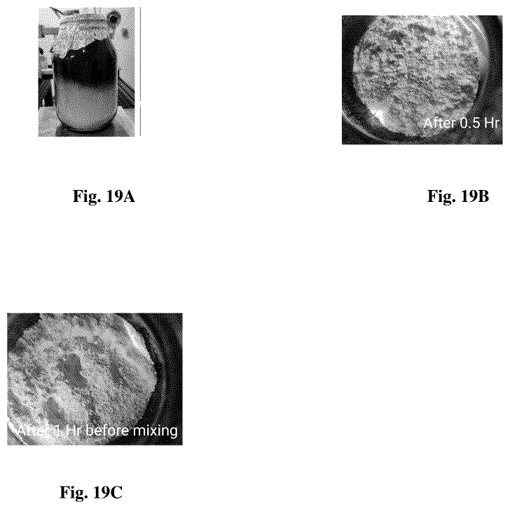

As can be seen in FIG. 19A, FIG. 19B, FIG. 19C taken prior to irradiation and after 0.5 hour and 1 hour, respectively, there was no visible discoloration or any change in the CeO₂.

Since no discoloration of the ceria was observed, it was suggested that only 1 oxygen atom was released per ceria molecule (CeO2), therefore there is no obvious discoloration since no cerium is formed.

### Hydrogen Release

### Nano Ceria Following 150 Min Irradiation

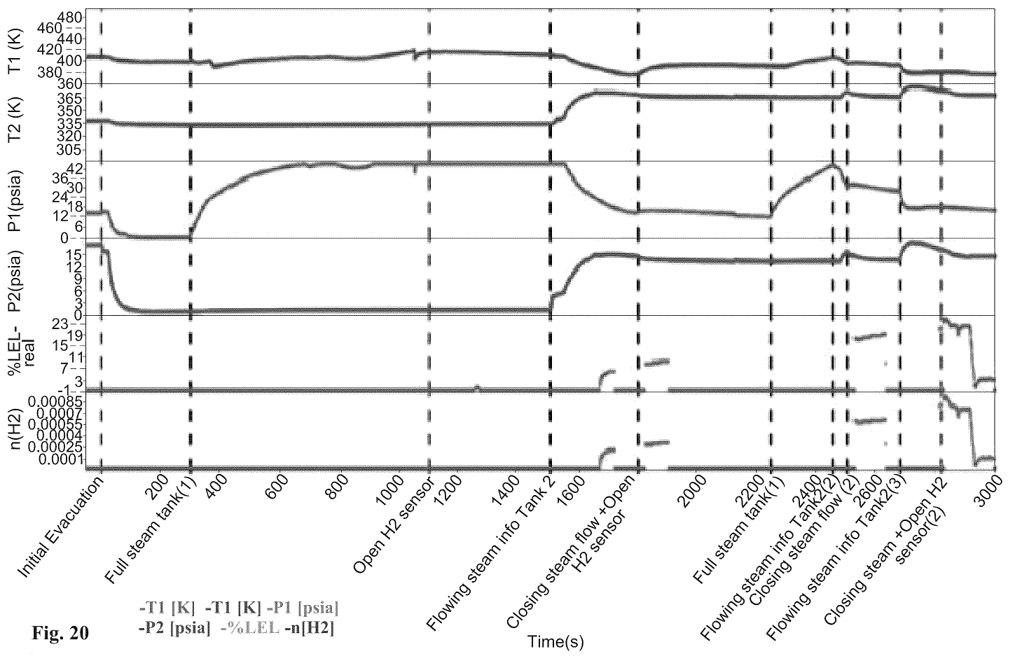

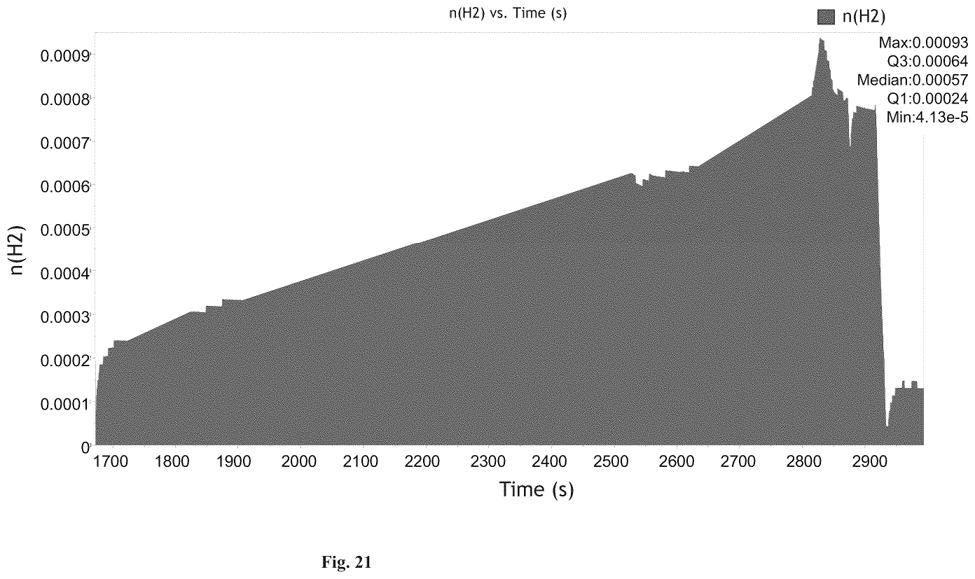

The irradiated Ceria was placed into the buckets inside tank 2 (show in FIG. 17B). The hydrogen release data are shown in FIG. 20.

By taking into account the % LEL ref of 12% and performing extrapolation and integrating over the H₂ production rate with respect to the relevant time interval, the total amount of hydrogen in this test was 0.35 mol→0.7 g per 21 min→average production rate of 0.03 g/min=1.8 g/hr.

FIG. 21 shows integration of H2 production in mols with respect to the amount of time to assess the total H2 production. Max production rate of 0.00093 mol/s=0.11 g/min=6.7 g/hr was measured—this depends on the amount of water vapor and Ceria in the chamber. The results suggest that oxygen vacancies were formed that were recombined with oxygen from the water vapor and enable generation of hydrogen.

### Example 2: Nano-Ceria Following 180 Min E-Beam Irradiation

Ceria with oxygen vacancies was placed into the buckets inside tank 2. % LEL ref is 12% and the total amount of hydrogen in this test was 0.22 mol→0.44 g per 11 min→average production rate of 0.04 g/min=2.4 g/hr.
Max production rate of 0.00047 mol/s=0.056 g/min=3.38 g/hr was measured.

### Example 3C: Nano-Ceria With Gamma Irradiation (Co⁶⁰)

### Irradiation and Oxygen Release

2 kg of Ceria was placed in a jar which was placed flush against the outer diameter of the source's cylinder. Source diameter=254 mm→I @ r=127 mm=0.7 MRad/hr.

The CeO₂ sample was irradiated continuously for 44 hr. There was no discoloration of the CeO₂ following the irradiation.

### Hydrogen Release Examination

Ceria was placed into the buckets inside tank 2—total mass of 120 g. % LEL ref is 21%. In this experiment, the max production rate obtained—0.0014 mol/s=0.17 g/min=10.08 g/hr.

According to the measured results of hydrogen production rate, 0.0014 mol/s, it can be concluded that the minimal rate of released oxygen is 0.0007 mol/s (per stoichiometry of the above reactions). This may indicate that the absorption probability is higher or that every impact release more than 1 oxygen atom.

1. A method comprising exposing metal oxide to a radiation, to obtain an oxygen vacancy metal oxide (OVMO) in said metal oxide and oxygen gas.

2. The method of claim 1, wherein during said exposing, the metal oxide is at a temperature below the temperature required to overcome the metal oxide binding energy.

3. The method of claim 1, wherein said radiation is non-thermal radiation.

4. The method of claim 1, wherein said radiation is selected from the group consisting of electron beam radiation, alpha radiation, beta radiation, gamma radiation, and UV radiation.

5. The method of claim 1, wherein said metal in said metal oxide is at least one of (i) at least one alkali metal, (ii) at least one alkaline earth metal, (iii) at least one transition metal, (iv) at least one lanthanide metal, (v) at least one actinide metal or (vi) combination thereof, optionally at least one of (i) at least one transition metal, (ii) at least one lanthanide metal, (iii) at least one actinide metal or (iv) combination thereof.

6. The method of claim 1, wherein said metal in said metal oxide is at least one of Zirconium (Zr), Cerium (Ce), Iron (Fe), Titanium (Ti), Nickel (Ni) or any combination thereof.

7. The method of claim 1, wherein said metal oxide is selected from the group consisting of ZrO₂, CeO₂, FeO, TiO and NiO.

8. The method of claim 1, wherein said metal oxide is in a solid state.

9. The method of claim 1, wherein said metal oxide is in a powder form or coating a surface.

10. The method of claim 1, comprising one or more of (i) collecting said oxygen gas, (ii) collecting said OVMO comprising oxygen vacancy, (iii) exposing said OVMO to water vapor, optionally comprising collecting hydrogen gas produced upon exposure of said OVMO to said water vapor.

11. A method comprising:
(i) exposing metal oxide to a radiation, to obtain OVMO and oxygen gas; and
(ii) exposing said OVMO to water vapor to regenerate said metal oxide particles and generate hydrogen gas.

12. The method of claim 11, comprising repeating steps (i) and (ii) to allow sequential generation of oxygen gas and hydrogen gas.

13. The method of claim 11, comprising collecting said oxygen gas, optionally comprising colleting said oxygen gas before step (ii).

14. The method of claim 11 comprising collecting said OVMO, optionally comprising colleting said OVMO before step (ii).

15. The method of claim 11, comprising collecting said hydrogen gas, optionally comprising collecting said hydrogen gas after step (ii).

16. A reactor comprising a reactor chamber including a gas outlet and a radiation source, the reactor chamber is configured for holding metal oxide such that upon radiation by said radiation source, said metal oxide particles are exposed to said radiation; and upon said exposure to radiation, gas is generated by said metal oxide and is being released from said chamber through said gas outlet.

17. The reactor of claim 16, wherein said radiation does not involve thermal radiation and/or said radiation source is a radioactive source.

18. The reactor of claim 16, wherein said metal oxide is configured to release oxygen atoms upon said exposure to radiation, to generate oxygen gas and a OVMO.

19. The reactor of claim 16, wherein said gas outlet (i) is configured for evacuating oxygen gas from said chamber, optionally comprising means to collect said OVMO from said chamber and/or (ii) is or comprises an hydrogen gas outlet.

20. The reactor of claim 16, comprising a water vapor reservoir, optionally wherein said OVMO is configured to generate hydrogen gas and undergo regeneration to obtain said metal oxide, upon exposure to water vapor from said water vapor reservoir.
